(19) United States
(12) Patent Application Publication
(10) Pub. No.: US 2025/0245594 A1
(43) Pub. Date: Jul. 31, 2025

(54) METHOD AND SYSTEM FOR ENHANCING MEDIA PRODUCTION

(71) Applicant: STRADA MEDIA, INC., Burbank, CA (US)

(72) Inventors: Michael CIONI, Burbank, CA (US); Peter CIONI, Burbank, CA (US); Austin CASE, Burbank, CA (US)

(21) Appl. No.: 19/039,508

(22) Filed: Jan. 28, 2025

Related U.S. Application Data
(60) Provisional application No. 63/626,018, filed on Jan. 28, 2024.

(51) Int. Cl. G06Q 10/0631; G06F 21/62; H04N 21/80

(52) U.S. Cl. CPC G06Q 10/06316; G06F 21/629; H04N 21/80

(57) ABSTRACT

Provided are computer-implemented technologies for facilitating the planning, development, creation, and execution of a media asset or audiovisual content (such as but not limited to a motion picture or portions thereof) within a single integrated intelligent platform/environment, orchestrated via network-connected storage devices, and advanced via artificial intelligence (AI) assistance, machine learning, technology-augmentation, and overall re-imagined and optimized workflows to improve the efficiency, accuracy, and effectiveness of media production.

### RELATED APPLICATIONS

This application claims the benefit of priority under 35 U.S.C. § 119 to U.S. Provisional Application No. 63/626,018, filed on Jan. 28, 2024, which is incorporated herein by reference.

### BACKGROUND

### 1. Field of Technology

The present invention relates to the field of media production (production of audiovisual content). Specifically, the present method and/or system relates to workflow enhancements and integration in the field of media production in minimizing the potential for unintended roadblocks in the creation process while upleveling the objective and subjective quality of the creative output.

### 2. Description of Related Art

The creation of a quality piece of Content—whether used for entertainment, education, business, or otherwise—involves a lot more than pressing “record” on a device. For a Content Creator, Content creation involves a complex workflow consisting of many steps, through which many files and file types need to be manipulated, by working on various platforms using various software. Assets need to be stored securely but easily accessed. Even selecting the right camera, microphones, software, or creative collaboration team can be a challenging endeavor, requiring an understanding of the various capabilities and limitations and how they align (or do not align) with the creative vision for the Finalized Project. Functions such as capturing, shipping, analyzing, logging, transcoding, editing, adding effects, color correcting, audio mixing, versioning, and distribution, just to name a few, are each essential to creating the Finalized Project.

Content creation is traditionally undertaken by addressing each of the above tasks sequentially. For each task, a variety of potential hardware and software solutions exist, and it is up to the Content Creator to weigh their relative advantages and disadvantages and select the solution that seems most optimal for delivering an output that is as close as possible to the Content Creator's vision for the Finalized Project. That determination of “most optimal” includes figuring out which solution provides the output that is most aesthetically and acoustically on-point, but also delivered while adhering to other specific constraints (e.g., time, budget, technical proficiency).

A vital but often overlooked aspect of the Content creation process is file formatting, media processing, and storage. Creating and storing a final, polished piece of Content involves the use of multiple solutions, developed and furnished by a variety of developers using proprietary systems. As a result, discrete intermediary media assets are often created in a variety of file types and stored in a variety of locations, many of which do not readily interface with each other and/or do not automatically convert from a file type that is non-usable in the next step in the sequential process.

Once the Content Creator has made choices about the type of solution they will employ for their project and has proceeded with creating intermediary media assets using those solution choices, the Content Creator may unfortunately face the situation that at least one of those choices severely compromises—or completely derails—the possibility of achieving the creative vision for the Finalized Project. The failure may be because that choice cannot deliver the type of sound, picture, or overall feel of the creative vision. Or the problem could be that one of the subsequent steps in the sequential process the Content Creator has embarked on requires a file type that is incompatible with the upstream choice the Content Creator made. Once the time and resources have been spent going down a particular pathway, there may not be the opportunity to rewind one or more steps to get back on track. Especially if several subsequent steps beyond the initial erroneous choice have been taken, Content Creators may find that they have crossed the point of no return, and that to avoid abandoning the project altogether, they will need to start making compromises on the original creative vision.

Exacerbating the situation is the modern “paradox of choice” by which more and more marketplace solutions (including artificial intelligence driven (AI-driven) tools) are presented to help Content Creators with specific aspects of the process, and yet this abundance of options amplifies the complexity and the potential for running into a dead end in the creation process without fulfilling the intended creative vision. Also, as the universe of Content Creators expands, incumbent tools and workflows exceed the proficiency of the average Content Creator.

Storage limitations, rendering speeds, and internet connectivity limits are additional hurdles that the modern Content Creator must overcome. Maintaining, securing, working on, and processing audiovisual Assets can require significant computing power, and operating on local computers can potentially slow down the creation process.

More specifically, video content production consists of numerous steps to eventually convert raw video elements into a finished product (the “End-Deliverable”) for an end-consumer. These steps can include, for example, capturing video elements on a digital camera, editing video elements, creating & adding visual effects elements, and/or creating & adding sound or music elements (each of which is an example of a “Raw Element”), all in an effort to create an End-Deliverable for distribution via YouTube, Vimeo, LinkedIn, Netflix, Disney, Instagram, and/or for internal use. Video content production can be a lengthy process, involving the creation of various drafts (“Versions”) prior to creating the End-Deliverable.

Collaboration is an essential element of video content production because the process of generating an End-Deliverable is the result of aggregating unique component parts: typically, a video content production builds a team comprised of individuals who each has unique skills & capabilities and, therefore, influences an aspect or component of the End-Deliverable. For example, a video content production team could include a director, cinematographer, writer, editor, visual effects artist, actor, and/or producer who all have unique responsibilities. The collaborative process ensures all the individual components, individual skills, and individual contributions work in unison. This is analogous to a symphonic orchestra, where musicians play specific instruments and read component parts of the overall musical score, but all musicians playing together (under the direction of a conductor) create the End-Deliverable envisioned by the composer.

In video content production specifically, collaboration commonly involves various members on the team being kept apprised of the status of various Versions, reviewing those Versions, submitting elements, and providing continuous feedback until the various elements are assembled together and deemed an End-Deliverable.

Today, collaboration during video content production is inefficient, costing companies, teams, and individuals billions of dollars annually in wasteful spending. The inefficiency can be found in areas like lost time, duplicative media, media management, multiple tools, and multiple systems of record.

Many other industries-including finance, engineering, and graphic design-have a similar need to collaborate on Versions in order to create the End-Deliverable, yet the collaboration process in these industries is much more efficient than in video content production, as they have benefited from the introduction of numerous innovations over the last 20 years. Some innovations include Google Docs (word processing), Airtable (spreadsheets & databases), GitHub (collaborative code review), Figma (creative design), and Dropbox (cloud-based storage and synchronization). These are all examples of leveraging cloud storage and cloud-native applications (“Cloud-Native Workflows”) to achieve efficient collaboration. There are numerous benefits to Cloud-Native Workflows:
Accessibility—Retrieve data from any device with an internet connection, regardless of location
Scalability—Grow infrastructure to meet increased demand
Resiliency—Maintain business operations even if there's a local issue
Cost efficiency—Save money on hardware and software
Security—Store information in a secure location
Centralization—Share information in a place where others can access

But, for the collaboration process via Cloud-Native Workflows to be efficient, participants (knowingly or unknowingly) adhere to the following:
Accept the cloud infrastructure paradigm of pay-as-you-go pricing for ingress, compute, and storage
Upload all Raw Elements to cloud storage via an internet connection, and/or create Raw Elements directly within the cloud-based infrastructure
Store all Raw Elements, Versions, and the End-Deliverable in cloud storage for extended periods of time
Utilize cloud-native software applications instead of downloadable consumer applications (the latter, “Legacy Applications”)

It seems plausible that video content production collaboration could improve efficiency by adopting Cloud-Native Workflows, given that the migration to the cloud has brought efficiency to many other industries. But video content production has inherent & unique characteristics not shared by other industries, making Cloud-Native Workflows incredibly challenging:
Each video element is large: the file sizes created by digital video cameras are, on average, significantly larger than Raw Elements utilized in other industries (e.g., PDF,.JPG,.DOC,.XLS). In fact, some cameras record 2.5 TB per hour of material. There's little evidence that the data rates of digital video cameras will decline in the foreseeable future; on the contrary, data rates tend to increase due to increased image resolution, color bit depth, bit rates, frame rates, and the overall processing power that exists inside the cameras themselves.
Video content production requires numerous video elements: video content production utilizes multiple “takes” of video elements in order for the team to create the best End-Result. In some types of content, the “Shooting Ratio” (which is the ratio of video elements vs. the End-Result) can exceed 200:1. In other words, an End-Result that is 1 hour in length (like a feature film shown in a movie theater) may be the result of recording 200 hours of video elements. This volume of Raw Elements is quite different from a collaborative process involving, for example, word processing, whereby all collaborative work occurs within one single Raw Element (e.g., DOC file).
Slow Internet upload speeds lead to delays in commencing a Cloud-Native Workflow: in many video content production instances, Raw Elements cannot be created natively within cloud-based infrastructure (e.g., if they're captured by a digital video camera). For a viable Cloud-Native Workflow, all video elements must first be uploaded to cloud storage prior to collaboration. Internet upload speeds vary depending on the video content production's location/level of service, but the average upload speed in the United States is currently 30 Mbps. At the same time, some digital video cameras today record video elements at 5,748 Mbps, which is 191 x more data than the average internet upload speed in the United States. In this case, 1 hour of video elements would take nearly 8 days to upload to cloud infrastructure on a standard internet subscription. With many video content productions requiring turnaround times of less than 24 hours, and with many video content productions having a Shooting Ratio greater than 1:1, the cloud is not a viable way to bring collaboration efficiency.
Pay-as-you-go pricing is prohibitively expensive: as mentioned previously, each video element can be a large file size, and the Shooting Ratio associated with video content production means numerous video elements. In aggregate, a single video content production can create a large “Data Footprint” (defined as the #of files multiplied by the average size per file), which can easily exceed 500 Terabytes. Pay-as-you-go pricing, a staple of cloud infrastructure, offers significant flexibility, but the tradeoff is unit pricing that is significantly more expansive than owning & amortizing the cost of the underlying infrastructure. Some examples of unit pricing include: renting cloud storage at a fixed monthly price per Terabyte, paying for Cloud egress at a fixed price per Gigabyte, renting cloud compute at a fixed price per hour of CPU usage.
With industries that have a very small Data Footprint, the impact of pay-as-you-go pricing might seem nominal/trivial. But with video content production, pay-as-you-go pricing is significant: for example, storing ITB of video elements on common hyperscale cloud providers is 40 x more expensive than purchasing an equivalent hard drive and amortizing that cost over a reasonable useful life of that physical drive. With many video content productions looking to save costs, with the Data Footprint of a video content production easily exceeding a 500 Terabytes in size, and the need to store video elements in perpetuity (e.g., for archive & asset re-use purposes), the cloud is not a viable way to bring collaboration efficiency.
The majority of software tools used for video content production are Legacy Applications: video content production is a process that relies on numerous specialized software applications to handle discrete tasks within the workflow (e.g., editing software, visual effects software, sound mixing software, rendering software). This is quite different from a process like word processing whereby a single tool (e.g., Google Docs) handles all aspects of the collaborative process. The most commonly used applications for video content production-made by companies including Apple, Adobe, Autodesk, AVID, The Foundry, and Blackmagic Design, among others-are still Legacy Applications, and thus cannot enable the video content production to take full advantage of cloud infrastructure. With most video content productions relying on these Legacy Applications, and with minimal effort to create competing tools that are cloud-native, the cloud is not a viable way to bring collaboration efficiency.
The Raw Elements need to be interoperable: as stated above, video content production needs to be collaborative because the process of generating an End-Deliverable is the result of individuals on a team influencing an aspect or component of the End-Deliverable. Additionally, specialized software applications are necessary to handle discrete tasks within the workflow. Taken together, this means each of the various software applications in the video content production ecosystem needs to be able to read and write elements created by the others. The cloud-native tools that do exist today for video content production combine the software application with the dedicated storage, which means any element stored in that cloud-native tool cannot be accessed by another tool. With video content productions requiring interoperability, the cloud is not a variable way to bring collaboration efficiency.

Based on the above, video content production cannot migrate exclusively to a Cloud-Native Workflow to achieve collaboration efficiency. However, certain phases & steps are handled via cloud-native technologies, including, for example, file transfer, synchronous review & approval, asynchronous review and approval, burst rendering, and remote editing. All of this effectively creates “Hybrid Workflows” involving both on-premises and cloud-based infrastructures. While unlocking certain collaboration opportunities, Hybrid Workflows introduce the following inefficiencies:
Lost time—to leverage cloud-based infrastructure for collaboration, video content production teams must upload Raw Elements to the cloud. As previously mentioned, the Data Footprint for video elements is large, meaning team members who need to review a Version must first wait for the Raw Element to be uploaded.
Duplicative media—to leverage cloud-based infrastructure for collaboration, video content production teams must upload media to specific cloud-native tools, each of which has dedicated storage. So, this requires the video content production team to complete a Raw Element upload for every process they want conducted in the cloud. For example, if Collaborator 1 on a team wants to transfer File “A” to Collaborator 2, wants to make that same File “A” available to Collaborator 2 for a-synchronous review, and also make File “A” available to Collaborator 2 for remote editing, Collaborator 1 would need to upload that file 3 x times to 3 x different cloud-native applications. In total, this workflow now has created 4 x copies of File “A.”
Media management—because of the known challenges of Cloud-Native workflows with video content production (e.g., lengthy upload timelines, expensive storage), video content production teams take on the additional burden of managing a subset of elements in order to offset those challenges. For example, a video content production will transcode all of the video elements into a more-compressed duplicate copy (a “Proxy File”). While this alleviates both the upload bottleneck and the expensive storage problem, it means there's an additional set of Raw Elements that need to be tracked/managed. Another example is uploading Raw Elements “as needed/as requested,” which helps minimize the storage expense, but creates an ongoing operational burden.
Multiple tools—because of the known challenges of Cloud-Native workflows and the proliferation of Legacy Applications, video content production teams are subscribing to numerous tools, which leads to increased subscription costs, and potentially multiple tools with overlapping features (but no single tool that handles all steps required by the video content production team).
Multiple systems of record and no automated source-of-truth-each cloud-native application has its own unique system of record that is not shared with other applications (either cloud-native application or legacy Application). As more cloud-native tools get built, this problem only compounds. Therefore, today, it's incumbent upon the video content production team to create manual records of, for example, the location of the Raw Elements, the status of the Raw Elements, and the current Version of the Raw Elements, and even the location of the End-Deliverable.

What video content production needs is a way to achieve the collaboration benefits afforded by cloud-native workflows (e.g., accessibility, scalability, resiliency, centralization), while working with the known constraints that exist with video content production (limited internet upload bandwidth, large Data Footprint, numerous Legacy Applications).

The above general description about the problems/challenges faced by the field of Creative Production can be summed up into the following seven major issues:

Issue 1: a collaborator on the video content production team has access to Raw Elements on their local computer (the “Content Owner”) that may be of use to fellow collaborators, but a) the Content Owner doesn't know what Raw Elements the fellow collaborators require and b) the collaborators don't know what exists in the Content Owner's Raw Elements. The Content Owner should be able to make available the Raw Elements to other collaborators a) without the Content Owner moving the Raw Elements from their local computer, b) without the Content Owner making a copy (or derivative) of the Raw Elements, c) enriched with metadata (including, without limitation, visual tags, face detection, text detection, emotion detection, object detection, transcriptions of audio, translation of audio) for simple navigation and search, and d) while taking into account user-defined & system-defined constraints of the Content Owner and collaborators (e.g., hard drive capacity, local computer power, internet upload bandwidth, internet download bandwidth, budget, security preferences) to optimize the intended result.

Issue 2: A collaborator on the video content production team (the “Reviewer”) needs to play—in an asynchronous fashion—a Version that was prepared by a collaborator (the “Creator”) and stored on the Creator's local computer. This asynchronous playback should be possible a) without the Creator moving the Version from their local computer, b) without the Creator making a copy (or derivative) of the Version, c) without the Creator being involved in the Reviewer's asynchronous playback, and d) while taking into account user-defined & system-defined constraints of the Reviewer and Creator (e.g., hard drive capacity, local computer power, internet upload bandwidth, internet download bandwidth, budget, security preferences) to optimize the intended result.

Issue 3: A collaborator on the video content production team (the “Remote Editor”) is working in a specialized Legacy Application and needs to utilize a Raw Element—which is stored locally with another collaborator—in order to develop a new Version. The ability for the Remote Editor to utilize the Raw Element should be possible a) without the collaborator moving the Raw Element from the current location, b) without the Creator making a copy (or derivative) of the Raw Element, and c) while taking into account user-defined & system-defined constraints of the Remote Editor and collaborator (e.g., hard drive capacity, local computer power, internet upload bandwidth, internet download bandwidth, budget, security preferences) to optimize the intended result.

Issue 4: A collaborator on the video content production team (the “Creator”) needs to leverage computing infrastructure to create a Raw Element or the End-Deliverable (the “Render”), but doesn't have adequate computing infrastructure locally to create it. At the same time, other collaborators on the video content production team a) have adequate computing infrastructure locally and b) have idle computing capacity to help create it (or even a portion). The ability for the Creator to utilize the available computing infrastructure of other collaborators should be possible a) without the Creator requesting the collaborator to make available their local infrastructure, b) without the Creator moving any components of the Render, and c) while taking into account user-defined & system-defined constraints of the Creator and collaborators (e.g., hard drive capacity, local computer power, internet upload bandwidth, internet download bandwidth, budget, security preferences) to optimize the intended result.

Issue 5: A collaborator on the video content production team (the “Remote Editor”) is working in a specialized Legacy Application and needs to utilize a Raw Element—which is not stored locally—in order to develop a new Version. The Content Owner has the Raw Element on their local computer, but the computer (and thus the Raw Element) is offline. The ability for the Remote Editor to utilize the Raw Element should be possible a) without the Content Owner moving the Raw Element from the current location, b) without the Content Owner making a copy (or derivative) of the Raw Element, and c) while taking into account user-defined & system-defined constraints of the Remote Editor, and the Content Owner (e.g., hard drive capacity, local computer power, internet upload bandwidth, internet download bandwidth, budget, security preferences) to optimize the intended result.

Issue 6: A collaborator on the video content production team is interested in experiencing the results of modifying certain Raw Elements-either by combining multiple Raw Elements together (e.g., combining multiple camera angles, combining audio with picture) or by adding enhancements to the Raw Elements (e.g., color correction, sound mixing, resolution upressing). The ability for the collaborator to experience the results of modifying Raw Element should be possible a) without the collaborator moving the Raw Element from its current location, b) without the collaborator making a copy (or derivative) of the Raw Element, c) in a non-permanent/non-destructive way, and c) while taking into account user-defined & system-defined constraints of the collaborator (e.g., hard drive capacity, local computer power, internet upload bandwidth, internet download bandwidth, budget, security preferences) to optimize the intended result.

Issue 7: A Content Owner has the Raw Element on a portable hard drive, and that drive goes offline, which affects all others who are utilizing that Raw Element. Once re-connected, that Raw Element should be available to other collaborators a) with minimal time re-indexing the Raw Element, b) with all previously-generated metadata intact, c) without collaborators being forced to re-link media, and d) while taking into account user-defined & system-defined constraints of the Content Owner and the collaborators (e.g., hard drive capacity, local computer power, internet upload bandwidth, internet download bandwidth, budget, security preferences) to optimize the intended result.

The various aspects involved in creating Content today, taken together, carry with them numerous junctures for a Content Creator to make suboptimal decisions or to become overwhelmed by an unwieldy level of complexity, resulting in problems, inefficiencies, and incompatibilities that could compromise the entire process. The present inventions technologically enhance the way in which Content is made by deconstructing and eliminating the issues outlined above.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The purpose of the present disclosure is to address the aforementioned issues and/or limitations in the field of media production, that is, to provide a technology-enabled and integrated system to eliminate or abate the bottlenecks encountered in media production workflow.

Provided is a computer-implemented method for enabling collaborations among a project lead and a plurality of collaborators, comprising: receiving or creating, by a plurality of collaborator computing systems, a plurality of media content fragments, storing the plurality of content fragments on the plurality of collaborator computing systems, surveying the plurality of collaborator computing systems to produce a set of collaborator data, each of which represents infrastructure constraints of the collaborator computing system being surveyed, transmitting the set of collaborator data to an input and constraint synthesizer, creating a set of project data by a project lead computer system, and transmitting the set of project data to the input and constraint synthesizer, wherein the input and constraint synthesizer aggregates the set of collaborator data and the set of project data, to produce a set of overall inputs and constraints, and transmits the set of overall inputs and constraints to an optimizer and orchestrator, receiving a media production workflow by the optimizer and orchestrator, producing, by the optimizer and orchestrator, based on the set of overall inputs and constraints, an optimized workflow, distributing the optimized workflow, according to a distribution plan specified in the optimized workflow, to a second plurality of collaborator computing systems wherein each of the collaborator computing systems in the second plurality of collaborator computing systems receives a portion of the optimized workflow to process, and collectively, the second plurality of collaborator computing systems produce a set of outputs, and wherein the second plurality of collaborator computing systems are a subset of the plurality of collaborator computing systems, assembling, by a product synthesizer, and according to the distribution plan, the set of outputs into a final product.

In one embodiment of the provided method, each of the set of collaborator data includes software, hardware and network constraints corresponding to a collaborator computing system of the set of plurality of collaborator computing systems, and the set of project data includes project type, available budget, available time, volume of work, security requirements, and project preferences.

Provided is another computer-implemented method for computing resources sharing among a plurality of computing systems to an overall computing system wherein the plurality of computer systems are communicatively connected, comprising: registering each of the plurality of computing systems to the overall computing system, surveying each of the plurality of computing systems for its software and hardware resources to produce a set of resource description data describing the software and hardware resources thereon, transmitting and registering the set of resource description data to a database, and installing an app on each of the plurality of computing systems wherein the app monitors the idle/active status of the computing system on which the app is installed, wherein the plurality of computing systems being registered include a first participant computing system, issuing a resource request, by the first computing system, to a controller that is communicatively connected with the overall computing system, wherein the resource request specifies a resource being requested and the characteristics of the resource being requested, searching the database, by the controller, to locate all computing systems being registered, sending a probing message to the app installed on each of the computing systems being registered to find out which have an idled and fitting resource, receiving a notification, by the controller, from each of the computing systems being registered via the app installed thereon wherein the notification indicates the idle/active status of the resource being requested on each of the computer systems being registered, and choosing a computing system that has an idle and fitting resource, connecting, by the controller, the first app on the first computing system and the second app on the computing system being chosen, the first app collaborating with the second app to avail the idled and fitting resource on the computing system being chosen to the first computing system.

In one embodiment of the computer-implemented method stated in the above paragraph, it further comprising: ensuring, by the second app, a user on the computing system being chosen is unable to see, access, and influence the use of the idled and fitting resource on the computing system being chosen once it is made available to be used by the first computing system.

Provided is another computer-implemented method for media content transferring among a plurality of disparate network-connected storage devices, comprising: for each media content located in each of the plurality of disparate network-connected storage devices, creating a registration therefor and storing the registration on a virtual folder or a workflow of a media content coordinator, wherein the registration therefor includes a description and a location thereof, receiving, by the media content coordinator, a content request from a content creator that has established log-in credentials with the media content coordinator, wherein the content request includes a description of a requested media content, searching and locating, by the media content coordinator, based on the content request, in the virtual folder or the workflow, the requested media content, transmitting the requested media content to the content creator.

In one embodiment of the computer-implemented method described in the above method, wherein creating the registration for the media content further comprises generating metadata for the media content, storing the registration further comprises storing the metadata along with the media content (with a unique identifier (like a UUID or “fuzzy hash”) being used to associate the media content with the metadata), and searching and locating further comprises searching for the description of the requested media content against metadata of all registered media contents and wherein transmitting the requested media content to the content creator is through virtualization or streaming.

In another embodiment of the computer-implemented method, wherein creating the registration for the media content and storing the registration further comprises indexing the media content and making the media content discoverable to the plurality of disparate network-connected storage devices.

Provided is another computer-implemented method for gamma-corrected and web-based viewing media content segments without altering the source of the media content segments, comprising: upon receiving a first viewing request from a device (whether it's a mobile device, computer, television, tablet, or otherwise) to view a color corrected version of a first media content segment, creating, via virtualization, a first play-back from the first media content segment in a memory or a temporary storage of a computer system to which the device is communicatively connected, applying, by the computer system, color correction to the first play-back to create a first streaming, transmitting the first streaming to the device for viewing, upon receiving a second viewing request from the device to view a combination of a second media content segment and a third media content segment, creating a second play-back from the second media content segment in the memory or a temporary storage of the computer system, creating a third play-back from the third media content segment in the memory or the temporary storage of the computer system, combining, by the computer system, the second play-back with the third play-back to create a second streaming, transmitting the second streaming to the device for viewing.

In one embodiment of the computer-implemented method described in previous paragraph, wherein applying, by the computer system, color correction to the first play-back to create a first streaming further comprising: taking into account a set of infrastructure constraints of the device requesting to view content, and wherein combining, by the computer system, the second play-back with the third play-back to create the second streaming further comprising: taking into account the set of infrastructure constraints of the device requesting to view content.

In another embodiment of the computer-implemented method, wherein applying, by the computer system, color correction to the first play-back to create a first streaming further comprising: taking into account a set of user-defined constraints and a set of infrastructure constraints of the device, and wherein combining, by the computer system, the second play-back with the third play-back to create the second streaming further comprising: taking into account a second set of user-defined constraints and the set of infrastructure constraints of the device, wherein the second set of user-defined constraints are supplied along with the first viewing request and/or the second viewing request.

Provided is another computer-implemented method for playing back a plurality of media content segments simultaneously without altering the source of the plurality of media content segments, comprising: upon receiving a viewing request from a device to view the plurality of media content segments, creating a plurality of copies of the plurality of media content segments in a memory or a temporary storage of a computer system to which the device is communicatively connected, wherein each of the plurality of copies corresponds to a media content segment of the plurality of media content segments, for each copy of the plurality of copies, retrieving, by the device, a time code embedded in each of the plurality of copies, to produce a plurality of time codes each of which corresponds to a copy of the plurality of copies, aligning, by the computer system, the plurality of time codes according to time values thereof, playing back and streaming to the web browser for viewing, by the computer system, the plurality of copies simultaneously and in-sync with to the plurality of time codes that have been aligned.

In one embodiment of the computer-implemented method described in the previous paragraph, wherein the playing back and streaming to the device for viewing takes into account the infrastructure constraints of the device.

In another embodiment of the computer-implemented method, wherein the playing back and streaming to the web browser for viewing takes into account a set of infrastructure constraints of the device and a set of user-defined constraints, wherein the set of user-defined constraints are supplied along with the viewing request.

In yet another embodiment of the computer-implemented method, wherein the playing back and streaming to the device for viewing further comprising: locally caching one or more specific user-defined moments of streaming, wherein the one or more specific user-defined moments are input from a user through the device.

Provided is another computer-implemented method for optimizing a media production workflow and tracking the costs of the workflow, comprising: retrieving the plurality of previously completed media production workflows from a database, wherein the plurality of previously completed media production workflows being retrieved are compositionally similar to a media production workflow, for each of the plurality of previously completed media production workflows being retrieved, retrieving the total costs incurred and total time consumed of the respective workflow, and the position-cost-time dataset of each step in the respective workflow to produce a set of previous data, producing an optimization configuration for the steps in the plurality of previously completed media production workflows being retrieved based on the set of previous data by shuffling the positions of each step in the plurality of previously completed media production workflows being retrieved to find out which order of execution of steps in the plurality of previously completed media production workflows being retrieved will result in the lowest total cost incurred and time consumed, wherein the optimal configuration encodes the order of execution of steps in the plurality of previously completed media production workflows being retrieved that will result in the lowest total cost incurred and time consumed, running the media production workflow according to the optimization configuration to obtain a recommended workflow, wherein the recommended workflow bears the closest compositional resemblance to the media production workflow, re-arranging the steps in the media production workflow according to the configuration of the recommended workflow to produce an optimized workflow for the media production workflow, running the optimized workflow, registering a position, a cost incurred and a time consumed in completing each step of the optimized workflow to produce a plurality of position-cost-time values respective to each completed step of the optimized workflow, upon completing the optimized workflow, tallying the plurality of position-cost-time values to produce a total cost value and a total time value associated with the optimized workflow, storing the optimized workflow along with the plurality of position-cost-time values, the total cost value and the total time value associated with the optimized workflow in the database.

Provided is yet another computer-implemented method for enhancing manual operations in a media production workflow, comprising: retrieving a plurality of previously completed media production workflows, wherein an overall preference of each of the plurality of previously completed media production workflows is known and quantitively encoded, and the preference and operational option of each step of the plurality of previously completed media production workflows are known and quantitively encoded, and wherein the plurality of previously completed media production workflows being retrieved are compositionally similar to the media production workflow, running the media production workflow through the plurality of previously completed media production workflows being retrieved to obtain a recommended workflow, wherein the recommended workflow's overall preference bears the closest resemblance to the media production workflow's overall preference, assigning a preference and operational option to each step in the media production workflow according to the preference and operational option associated with the corresponding step in the recommended workflow to produce an enhanced workflow for the media production workflow, running the enhanced workflow, wherein the running is carried on, without human interference, by executing each step therein according to the assigned preference and operational option thereof.

Provided is yet another computer-implemented method for expediting operations in a media production workflow, comprising: retrieving a plurality of steps from the media production workflow, conducting dependency analysis on the plurality of steps to build a diagram of dependency for the plurality of steps, wherein the diagram of dependency specifies a number of dependency links among the plurality of distinct steps, retrieving a plurality of previously completed and compositionally similar media production workflows, wherein the cost incurred and time consumed are known for each step of the plurality of previously completed and compositionally similar media production workflows, for each of the plurality of previously completed and compositionally similar media production workflows, tallying the total costs incurred, total time consumed, individual cost incurred in each step, and individual time consumed in each step, and the position of each step in the respective previously completed and compositionally similar media production workflow to produce a plurality of cost-time constraints each of which corresponds to each of the plurality of previously completed and compositionally similar media production workflows, wherein each of the plurality of cost-time constraints includes constraint datapoints encompassing cost incurred, time consumed and position for each step in a workflow of the plurality of previously completed and compositionally similar media production workflows, for each of the plurality of previously completed and compositionally similar media production workflows, analyzing each step therein to identify virtually-executable steps therein that can be executed virtually in a memory or a temporary storage without being actually executed in a production storage, to assemble a plurality of virtually-executable step tables containing such steps for the plurality of previously completed and compositionally similar media production workflows, running the media production workflow through the plurality of previously completed and compositionally similar media production workflows being retrieved to obtain a recommended workflow, wherein the recommended workflow bears the lowest cost incurred and time consumed, retrieving a recommended set of cost-time constraints from the plurality of cost-time constraints corresponding to the recommended workflow, and a recommended virtually-executable step table from the plurality of virtually-executable step tables corresponding to the recommended workflow, reconciling the diagram of dependency, the recommended set of cost-time constraints, and the recommended virtually-executable step table to produce a parallelization plan, wherein each parallelization specifies two or more steps of the media production workflow that are executed in parallel by two or more collaborators, and each parallelization conforms with the diagram of dependency, optimally conforms with the recommended set of cost-time constraints, and conforms with the recommended set of virtually-executable step tables, executing the recommended workflow according to the parallelization plan.

Provided is another computer-implemented method for enabling query media fragments stored in a plurality of networked storage devices of a media production environment, comprising:
communicatively connecting and granting access the media production environment to the plurality of networked storage devices, traversing, by the media production environment, through the plurality of networked storage devices to identify a plurality of media fragments contained therein, producing, for each of the plurality of media fragments, a metadata describing each of the plurality of media fragments wherein the metadata contains an unique identifier for each of the plurality of media fragments and an unique address in the plurality of networked storage device, analyzing each of the plurality of media fragments to detect an existence of each of a plurality of pre-defined subject matters, upon detecting the existence thereof, adding the names of detected subject matters as tags to the metadata, storing the metadata along with each of the plurality of media fragments in a database communicatively connected to the media production environment, receiving, by the media production environment, a media fragment query, wherein the query includes a plurality of descriptive keywords, conducting, by the media production environment, a database search against the database, wherein the database search entails comparing the plurality of descriptive keywords with the tags in each of metadata stored in the database, presenting a plurality of matched metadata, each of which matches at least one of the plurality of descriptive keywords, wherein the plurality of matched metadata each has an URL (Uniform Resource Locator) representing an identifiable location within the plurality of network storages for accessing the associated media fragment.

In one embodiment of the computer-implemented method of claims described above, further comprising: updating the plurality of pre-defined subject matters, traversing, by the media production environment, through the plurality of networked storage devices to identify a plurality of media fragments contained therein, analyzing, by the media production environment, each of the plurality of media fragments to detect the existence of each of the plurality of pre-defined subject matters that have just been updated, upon detecting an existence thereof, retrieving the metadata associated with each of the plurality of media fragments from the database system and updating, by overwriting the tags therein with the names of detected subject matters as tags.

In another embodiment of the computer-implemented method, further comprising: upon adding a new media fragment in the plurality of networked storage devices, producing, by the media production environment, a new metadata describing the new media fragment wherein the new metadata contains a new unique identifier for the new media fragment and a new unique address in the plurality of networked storage devices, analyzing the new media fragment to detect an existence of each of the plurality of pre-defined subject matters, upon detecting the existence thereof, adding the names of detected subject matter as tags to the new metadata, storing the new metadata in the database system.

In another embodiment of the computer-implemented method, wherein storing the metadata along with each of the plurality of media fragments in the database system communicatively connected to the media production environment further comprising: indexing each of the plurality of media fragments according to its metadata and making each of the plurality of media fragments discoverable according to its metadata.

In yet another embodiment of the computer-implemented method of claim 18, further comprising: upon detecting a media fragment that is previously stored and indexed in the database system being offline for a user-defined time period, designating, in the database system, the media fragment as “offline”, making the media fragment inaccessible and undiscoverable, upon detecting a media fragment that is designated as “offline” becoming online, removing, in the database system, the designation of “offline” from the media fragment, making the media fragment accessible and discoverable.

Provided is a media content creation and collaboration system, comprising: a plurality of collaborator computing systems, a project lead computing system, an inputs and constraints synthesizer system, a product synthesizer, and an optimizer and orchestrator, wherein the plurality of collaborator computing systems, the project lead computing system, the inputs and constraints synthesizer system, the product synthesizer and the optimizer and orchestrator are communicatively connected, and the media content creation and collaboration system to perform operations comprising: receiving or creating, by the plurality of collaborator computing systems, a plurality of media content fragment, storing the plurality of content fragment on the plurality of collaborator computing systems, surveying the plurality of collaborator computing systems to produce a set of collaborator data each of which represents infrastructure constraints of the collaborator computing system being surveyed, transmitting the set of collaborator data, to an input and constraint synthesizer, creating a set of project data by a project lead computer system, and transmitting the set of project data to the input and constraint synthesizer, wherein the input and constraint synthesizer aggregates the set of collaborator data and the set of project data, to produce a set of overall inputs and constraints, and transmitting the set of overall inputs and constraints to the optimizer and orchestrator, receiving a media production workflow by the optimizer and orchestrator, producing, by the optimizer and orchestrator, based on the set of overall inputs and constraints, an optimized workflow, distributing the optimized workflow, according to a distribution plan specified in the optimized workflow, to a second plurality of collaborator computing systems wherein each of the collaborator computing systems in the second plurality of collaborator computing systems receives a portion of the optimized workflow to process, and collectively, the second plurality of collaborator computing systems produce a set of outputs, and wherein the second plurality of collaborator computing systems are a subset of the plurality of collaborator computing systems, assembling, by a product synthesizer, and according to the distribution plan, the set of outputs into a final product.

In one embodiment of the system described above, wherein each of the set collaborator data includes software, hardware and network constraints corresponding to a collaborator computing system of the set of plurality of collaborator computing systems, and the set of project data includes project type, available budget, available time, volume of work, security requirements, and project preferences.

Provided is a media content creation and collaboration system, comprising: a controller, a database, a plurality of computing systems, wherein the plurality of computing systems, the controller, and the database are communicatively connected, and the controller is a computer or a software module hosted in a computer, and the media content creation and collaboration system to perform operations comprising: registering each of the computing systems to the media content creation and collaboration system, and for each of the computing systems, surveying software and hardware resources thereon to produce a set of resource description data describing the software and hardware resources thereon, transmitting and registering the set of resource description data to the database, and installing an app on each of the computing systems wherein the app monitoring each of the computing system's idle/active status, wherein the computing systems include a first computing system, issuing a resource request, by the first computing system, to the controller, wherein the resource request specifies a resource being requested and the characteristics of the resource being requested, searching the database, by the controller, to locate all registered computing systems, sending a probing message to the app installed on each of the registered computing systems to find out which of the registered computing systems have idle resources, receiving a notification, by the controller, from each of the registered computing systems via the app installed thereon wherein the notification indicates the idle/active status of each of the registered computer systems, and choosing a computing system that has an idle and fitting resource, connecting, by the controller, the first app on the first computing system and the second app on the computing system being chosen, the first app collaborating with the second app to avail an idled and fitting resource on the computing system being chosen to the first computing system.

In one embodiment of the media content creation and collaboration system stated above, the media content creation and collaboration system to perform operations further comprising: ensuring, by the second app, a user on the computing system being chosen is unable to see, access, and influence the use of the idled and fitting resource on the computing system being chosen once it is made available to be used by the first computing system.

Provided is a media content transferring system, comprising: a plurality of disparate network-connected storage devices, a media content coordinator that has a virtual folder, wherein the plurality of disparate network-connected storage devices and the media content coordinator are communicatively connected, and the media content coordinator to perform operations comprising: for each media content located in each of the plurality of disparate network-connected storage devices, creating a registration therefor and storing the registration on a virtual folder or a workflow of the media content coordinator, wherein the registration therefor includes a description thereof and a location thereof, receiving, by the media content coordinator, a content request from a content creator that has established log-in credentials with the media content coordinator, wherein the content request includes a description of a requested media content, searching and locating, by the media content coordinator, based on the content request, in the virtual folder or the workflow, the requested media content, transmitting the requested media content to the content creator.

In one embodiment of the media content transferring system stated above, wherein creating the registration for the media content further comprises generating metadata for the media content, storing the registration further comprises storing the metadata along with the media content, and searching and locating further comprises searching for the description of the requested media content against metadata of all registered media contents, and wherein transmitting the requested media content to the content creator is through virtualization or streaming.

In another embodiment of the media content transferring system, wherein creating the registration for the media content and storing the registration further comprises indexing the media content and making the media content discoverable to the plurality of disparate network-connected storage devices.

Provided is a media content viewing system, comprising: a web browser, a computer system that hosts a plurality of media content segments, and the media content viewing system to perform operations comprising: upon receiving a first viewing request from a device (whether it's a mobile device, computer, television, tablet, or otherwise) to view a color corrected version of a first media content segment, creating, via virtualization, a first play-back from the first media content segment in a memory or a temporary storage of a computer system to which the device is communicatively connected, applying, by the computer system, color correction to the first play-back to create a first streaming, transmitting the first streaming to the device for viewing, upon receiving a second viewing request from the web browser to view a combination of a second media content segment and a third media content segment, creating a second play-back from the second media content segment in the memory or a temporary storage of the computer system, creating a third play-back from the third media content segment in the memory or the temporary storage of the computer system, combining, by the computer system, the second play-back with the third play-back to create a second streaming, transmitting the second streaming to the device for viewing.

In one embodiment of the media content viewing system stated above, wherein applying, by the computer system, color correction to the first play-back to create a first streaming further comprising: taking into account a set of infrastructure constraints of the device, and wherein combining, by the computer system, the second play-back with the third play-back to create the second streaming further comprising: taking into account the set of infrastructure constraints of device.

In another embodiment of the media content viewing system, wherein applying, by the computer system, color correction to the first play-back to create a first streaming further comprising: taking into account a set of user-defined constrains and a set of infrastructure constraints of the device, and wherein combining, by the computer system, the second play-back with the third play-back to create the second streaming further comprising: taking into account a second set of user-defined constraints and the set of infrastructure constraints of the device, wherein the second set of user-defined constraints are supplied along with the first viewing request and/or the second viewing request.

Provided is a media content viewing system, comprising: a device, a computer system that hosts a plurality of media content segments, and the media content viewing system to perform operations comprising: upon receiving a viewing request from the device to view the plurality of media content segments, creating a plurality of copies of the plurality of media content segments in a memory or a temporary storage of the computer system to which the device is communicatively connected, wherein each of the plurality of copies corresponds to a media content segment of the plurality of media content segments, for each copy of the plurality of copies, retrieving, by the device, a time code embedded in each of the plurality of copies, to produce a plurality of time codes each of which corresponds to a copy of the plurality of copies, aligning, by the device, the plurality of time codes according to time values thereof, playing back and streaming to the device for viewing, by the device, the plurality of copies simultaneously and in-sync with the plurality of time codes that have been aligned.

In one embodiment of the media content viewing system stated above, wherein the playing back and streaming to the device for viewing takes into account the infrastructure constraints of the device.

In another embodiment of the media content viewing system, wherein the playing back and streaming to the device for viewing takes into account a set of infrastructure constraints of the device and a set of user-defined constraints, wherein the set of user-defined constraints are supplied along with the viewing request.

In yet another embodiment of the media content viewing system, wherein the playing back and streaming to the device for viewing further comprising: locally caching one or more specific user-defined moments of streaming, wherein the one or more specific user-defined moments are input from a user through the device.

Provided is a media production workflow optimization and cost-tracking system, comprising: a database that stores a plurality of previously completed media production workflows, wherein the composition and configuration of each of the plurality of previously completed media production workflows are recorded, and the position, cost incurred and time consumed of each of the steps (position-cost-time dataset) in each of the plurality of previously completed media production workflows are recorded, a computer system that is communicatively connected to the database, and hosts a media content workflow, and the computer system to perform operations comprising: retrieving the plurality of previously completed media production workflows from the database, wherein the plurality of previously completed media production workflows being retrieved are compositionally similar to the media production workflow, for each of the plurality of previously completed media production workflows, retrieving the total costs incurred and total time consumed of the respective workflow, and the position-cost-time dataset of each step in the respective workflow to produce a set of previous data, producing an optimization configuration for the steps in the plurality of previously completed media production workflows being retrieved based on the set of previous data by shuffling the positions of each step in the plurality of previously completed media production workflows being retrieved to find out which order of execution of steps in the plurality of previously completed media production workflows being retrieved would result in the lowest total cost incurred and time consumed, wherein the optimal configuration encodes the order of execution of steps in the plurality of previously completed media production workflows being retrieved that will result in the lowest total cost incurred and time consumed, running the media production workflow according to the optimization configuration to obtain a recommended workflow, wherein the recommended workflow bears the closest compositional resemblance to the media production workflow, re-arranging the steps in the media production workflow according to the configuration of the recommended workflow to produce an optimized workflow for the media production workflow, running the optimized workflow, registering a position, a cost incurred and a time consumed in completing each step of the optimized workflow to produce a plurality of position-cost-time values respective to each completed step of the optimized workflow, upon completing the optimized workflow, tallying the plurality of position-cost-time values to produce a total cost value and a total time value associated with the optimized workflow, storing the optimized workflow along with the plurality of position-cost-time values, the total cost value and the total time value associated with the optimized workflow in the database.

Provided is a media production workflow enhancement system, comprising: a database system that stores a plurality of previously completed media production workflows, wherein an overall preference of each of the plurality of previously completed media production workflows is known and quantitively encoded, and the preference and operational option of each step of the plurality of previously completed media production workflows are known and quantitively encoded, a computer system that is communicatively connected to the database system, and hosts a media content workflow, and the computer system to perform operations comprising: retrieving a plurality of previously completed and similar media production workflows from the database system, wherein the plurality of previously completed and similar media production workflows are compositionally similar to a media production workflow, running the media production workflow through the plurality of previously completed and similar media production workflows to obtain a recommended workflow, wherein the recommended workflow's overall preference bears the closest resemblance to the media production workflow's overall preference, assigning a preference and operational option to each step in the media production workflow according to the preference and operational option associated with the corresponding step in the recommended workflow to produce an enhanced workflow for the media production workflow, running the enhanced workflow, wherein the running is carried on, without human interference, by executing each step therein according to the assigned preference and operation option thereof.

Provided is a media production workflow parallelization system, comprising: a database system that stores a plurality of previously completed media production workflows, wherein the composition and configuration of each of the plurality of previously completed media production workflows are recorded, and the cost incurred and time consumed by each of the steps in each of the plurality of previously completed media production workflows are recorded, a computer system that is communicatively connected to the database system, and hosts a media content workflow, and the computer system to perform operations comprising: retrieving a plurality of steps from the media production workflow, conducting dependency analysis on the plurality of steps to build a diagram of dependency for the plurality of steps, wherein the diagram of dependency specifies a number of dependency links among the plurality of distinct steps, retrieving a plurality of previously completed and compositionally similar media production workflows from the database system, for each of the plurality of previously completed and compositionally similar media production workflows, tallying the total costs incurred, total time consumed, individual cost incurred in each step, and individual time consumed in each step, and the position of each step in the respective previously completed media production workflow to produce a plurality of cost-time constrains each of which corresponds to each of the plurality of previously completed and compositionally similar media production workflows, wherein each of the plurality of cost-time constrains includes constraint datapoints encompassing cost incurred, time consumed and position for each step in a workflow of the plurality of previously completed and compositionally similar media production workflows, for each of the plurality of previously completed and compositionally similar media production workflows, analyzing each step therein to identify virtually-executable steps therein that can be executed virtually in a memory or a temporary storage without being actually executed in a production storage, to assemble a plurality of virtually-executable step tables containing such steps for the plurality of previously completed and compositionally similar media production workflows, running the media production workflow through the plurality of previously completed and compositionally similar media production workflows being retrieved to obtain a recommended workflow, wherein the recommended workflow bears the lowest cost incurred and time consumed, retrieving a recommended set of cost-time constrains from the plurality of cost-time constraints corresponding to the recommended workflow, and a recommended virtually-executable step table from the plurality of virtually-executable step tables corresponding to the recommended workflow, reconciling the diagram of dependency, the recommended set of cost-time constraints, and the recommended virtually-executable step table to produce a parallelization plan, wherein each parallelization specifies two or more steps of the media production workflow are executed in parallel by two or more collaborators, and each parallelization conforms with the diagram of dependency, optimally conforms with the recommended set of cost-time constraints, and conforms with the recommended set of virtually-executable step tables, executing the recommended workflow according to the parallelization plan.

Provided is a media query system, comprising: a database, a media production environment communicatively connected to the database, the media production environment to perform operations comprising: communicatively connecting the media production environment to the plurality of networked storage devices and obtaining access to the networked storage devices, traversing, by the media production environment, through the plurality of networked storage devices to identify a plurality of media fragments contained therein, producing, for each of the plurality of media fragments, metadata describing each of the plurality of media fragments wherein the metadata contains an unique identifier for each of the plurality of media fragments and an unique address in the plurality of networked storage devices, analyzing each of the plurality of media fragments to detect an existence of each of a plurality of pre-defined subject matters, upon detecting the existence thereof, adding the names of detected subject matters as tags to the metadata, storing the metadata in the database system, receiving, by the media production environment, a media fragment query, wherein the query includes a plurality of descriptive keywords, conducting, by the media production environment, a database search against the database, wherein the database search entails comparing the plurality of descriptive keywords with the tags in each of metadata stored in the database system, presenting a plurality of matched metadata each of which matches at least one of the plurality of descriptive keywords, wherein the plurality of matched metadata each has an URL (Uniform Resource Locator) representing an identifiable location within the plurality of network storages for accessing the associated media fragment.

In one embodiment of the media query system described above, the media production environment to perform operation further comprising: updating the plurality of pre-defined subject matters, traversing, by the media production environment, through the plurality of networked storage devices to identify a plurality of media fragments contained therein, analyzing, by the media production environment, each of the plurality of media fragments to detect the existence of each of the plurality of pre-defined subject matters that have just been updated, upon detecting an existence thereof, retrieving the metadata associated with each of the plurality of media fragments from the database system and updating, by overwriting the tags therein with the names of detected subject matters as tags.

In another embodiment of the media query system, the media production environment to perform operation further comprising: upon adding a new media fragment in the plurality of networked storage devices, producing, by the media production environment, a new metadata describing the new media fragment wherein the new metadata contains a new unique identifier for the new media fragment and a new unique address in the plurality of networked storage devices, analyzing the new media fragment to detect an existence of each of the plurality of pre-defined subject matters, upon detecting the existence thereof, adding the names of detected subject matters as tags to the new metadata, storing the new metadata in the database system.

In yet another embodiment of the media query system, wherein storing the metadata along with each of the plurality of media fragments in the database communicatively connected to the media production environment further comprising: indexing each of the plurality of media fragments according to its metadata and making each of the plurality of media fragments discoverable according to its metadata.

In yet another embodiment of the media query system, the media production environment to perform operations further comprising: upon detecting a media fragment that is previously stored and indexed in the database system being offline for a user-defined time period, designating, in the database system, the media fragment as “offline”, making the media fragment inaccessible and undiscoverable, upon detecting a media fragment that is designated as “offline” becoming online, removing, in the database system, the designation of “offline” from the media fragment, making the media fragment accessible and discoverable.

Other features and aspects will be apparent from the following detailed description, the drawings, and the claims.

### BRIEF DESCRIPTION OF THE DRAWINGS

The present invention is illustrated by way of example and not limited in the figures of the accompanying drawings in which like references indicate similar elements.

FIG. 1 illustrates, in a schematic block diagram, a computing environment being used in accordance with all embodiments. The environment, in all embodiments, may include artificial intelligence (AI) or machine learning (ML) features (not shown, but are implicitly represented as Computer Programs). The environment, in all embodiments, may also include ancillary software modules (not shown, but are implicitly represented as Computer programs).

FIG. 2 schematically illustrates a computer-enabled system that facilitates utilization of resources on idle participant computers, within a media production environment.

FIG. 3 schematically illustrates a system and steps for transferring media contents among network-connected storage devices, within a media production environment.

FIG. 4 schematically illustrates a composition and configuration of a media production environment.

FIG. 5 illustrates a schematic diagram for an automatic metadata enrichment process, within a media production environment.

FIG. 6 illustrates a flowchart of the real-time playing back a media file, within a media production environment.

FIG. 7 illustrates a flowchart of editing a cached media file, within a media production environment.

FIG. 8 illustrates a flowchart of sharding rendition of a media file within a media production environment.

FIG. 9 illustrates a flowchart of identifying media asset's uniqueness/characteristics within a media production environment, at accelerated speeds.

FIG. 10 illustrates a schematic diagram of a system and steps for optimizing a media production flow within a media production environment.

FIG. 11 illustrates a schematic diagram of a system and steps for enhancing manual operations in media production within a media production environment.

FIG. 12 illustrates steps for parallelizing a media production workflow within a media production environment.

### DETAILED DESCRIPTION

Various embodiments and aspects of the inventions will be described with reference to details discussed below, and the accompanying drawings will illustrate some embodiments. The following description and drawings are illustrative of the invention and are not to be construed as limiting the scope of the invention. Numerous specific details are described to provide an overall understanding of the present invention to one of ordinary skill in the art.

Reference in the specification to “one embodiment” or “an embodiment” or “another embodiment” means that a particular feature, structure, or characteristic described in conjunction with the embodiment can be included in at least one embodiment of the invention but need not be in all embodiments. The appearances of the phrase “in one embodiment” in various places in the specification do not necessarily all refer to the same embodiment.

Embodiments use a computer-enabled system for enhancing media production.

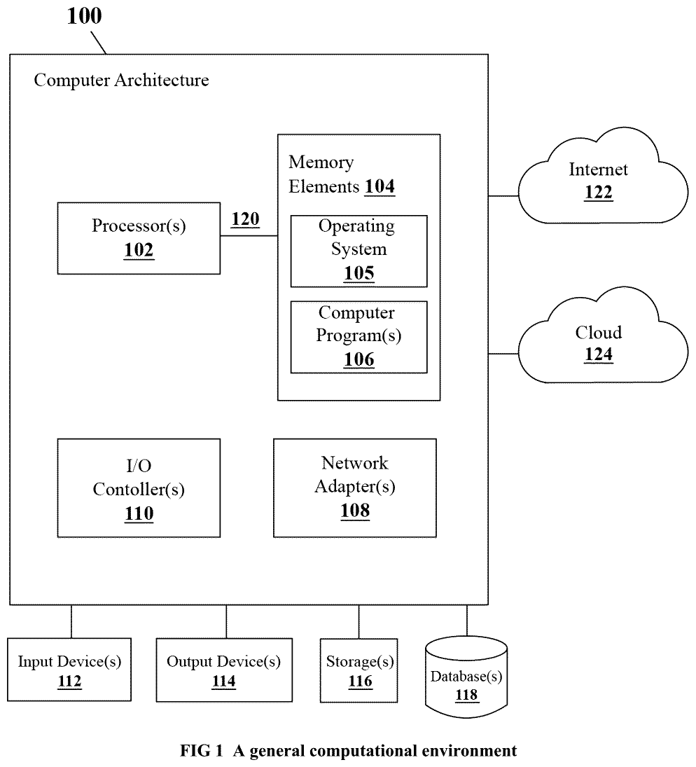

FIG. 1 illustrates a computer architecture 100 that may be used in accordance with certain embodiments. In certain embodiments, the raw sports data collection, storage, and process use computer architecture 100. The computer architecture 100 is suitable for storing and/or executing computer readable program instructions and includes at least one processor 102 coupled directly or indirectly to memory elements 104 through a system bus 120. The memory elements 104 may include one or more local memories employed during actual execution of the program code, bulk storage, and cache memories which provide temporary storage of at least some program code in order to reduce the number of times code must be retrieved from bulk storage during execution. The memory elements 104 include an operating system 105 and one or more computer programs 106, and the operating system 105, as understood by one skilled in the computer art, controls the operation of the entire computer architecture 100 and the architecture 100′s interaction with components coupled therewith such as the shown components (input device(s) 112, output device(s) 114, storage(s) 116, databases 118, internet 122, and cloud 124) and unshown components that are understood by one skilled in the art, and the operating system 105 may be switched and changed as fit.

Input/Output (I/O) devices 112, 114 (including but not limited to keyboards, displays, pointing devices, transmitting device, mobile phone, edge device, verbal device such as a microphone driven by voice recognition software or other known equivalent devices, etc.) may be coupled to the system either directly or through intervening I/O controllers 110. More pertinent to the embodiments of disclosure are photographing devices as one genre of input device. A photographing device can be a camera, a mobile phone, a drone that is equipped with a camera, an edge device that is equipped with a camera, or any other device that can capture one or more images/videos of an object (or a view) via various means (such as optical means or radio-wave based means), store the captured images/videos in some local storage (such as a memory, a flash disk, or the like), and to transmit the captured images/videos, as input data, to either a more permanent storage (such as a database 118, a storage 116) or at least one processor 102, depending on the demand of to where the captured images/videos are to be transmitted.

Input Devices 112 receive input data (raw and/or processed), and instructions from a user or other source. Input data includes, inter alia, (i) captured images, (ii) captured videos, (iii) captured audios, and (iv) computer or AI generated images/videos/audios.

Network adapters 108 may also be coupled to the system to enable the data processing system to become coupled to other data processing systems or remote printers or storage devices through intervening private or public networks. Modems, cable modems and Ethernet cards are just a few of the currently available types of network adapters 108. Network adapters 108 may also be communicatively coupled to internet 122 and/or cloud 124 to access remote computer resources such as on-premise computing systems (not shown in FIG. 1).

The computer architecture 100 may be coupled to storage 116 (e.g., any type of storage device; a non-volatile storage area, such as magnetic disk drives, optical disk drives, a tape drive, etc.). The storage 116 may comprise an internal storage device or an attached or storage accessible by other protocols (e.g., fibre-channel, network). Computer programs 106 in storage 116 may be loaded into the memory elements 104 and executed by a processor 102 in a manner known in the art.

Computer programs 106 may include AI programs or ML programs, primary media processing programs, and ancillary programs, and the computer programs 106 may partially reside in the memory elements 104, and partially reside in storage 116 and partially reside in cloud 124 or in an on-remise computing system via internet 122.

The computer architecture 100 may include fewer components than illustrated, additional components not illustrated herein, or some combination of the components illustrated and additional components. The computer architecture 100 may comprise any computing device known in the art, such as a mainframe, server, personal computer, workstation, laptop, handheld computer, telephony device, network appliance, virtualization device, storage controller, virtual machine, smartphone, tablet, etc.

Input device(s) 112 transmits input data to processor(s) 102 via memory elements 104 under the control of operating system 105 and computer program(s) 106. The processor(s) 102 may be central processing units (CPUs) and/or any other types of processing device known in the art. In certain embodiments, the processing devices 102 are capable of receiving and processing input data from multiple users or sources, thus the processing devices 102 have multiple cores. In addition, certain embodiments involve the use of videos (i.e., graphics intensive information) or digitized information (i.e., digitized graphics), these embodiments therefore employ graphic processing units (GPUs) as the processor(s) 102 in lieu of or in addition to CPUs.

Certain embodiments also comprise at least one database 118 for storing desired data. Some raw input data are converted into digitized data format, or broken into more manageable fragments via sharding before being stored in the database 118 or being used to create the desired output data. It's worth noting that storage(s) 116, in addition to being used to store computer program(s) 106, are also sometimes used to store input data, raw or processed, and to store intermediate data. The permanent storage of input data and intermediate data is primarily database(s) 118. It is also noted that the database(s) 118 may reside in close proximity to the computer architecture 100, or remotely in the cloud 124, and the database(s) 118 may be in various forms or database architectures. In some embodiments, the database(s) 118 may be a distributed database in a sense that the data are spread across the networked storage devices within a media production environment while the management module of the data is hosted on one of the computers within the media production environment

Computer Architecture 100 generically represents both an edge-device, a computer server, or an ensemble of computer servers, a mobile computing device (such as a mobile phone), or communicatively coupled and distributed computing resources that collectively have the elements and structures of the Computer Architectures 100.

Because certain embodiments need a storage for storing large volumes of photo image/video/audio data, more than one database likely is used.

The provided method and/or system involves technologically enhancing and streamlining various time-consuming or costly aspects of a media production.

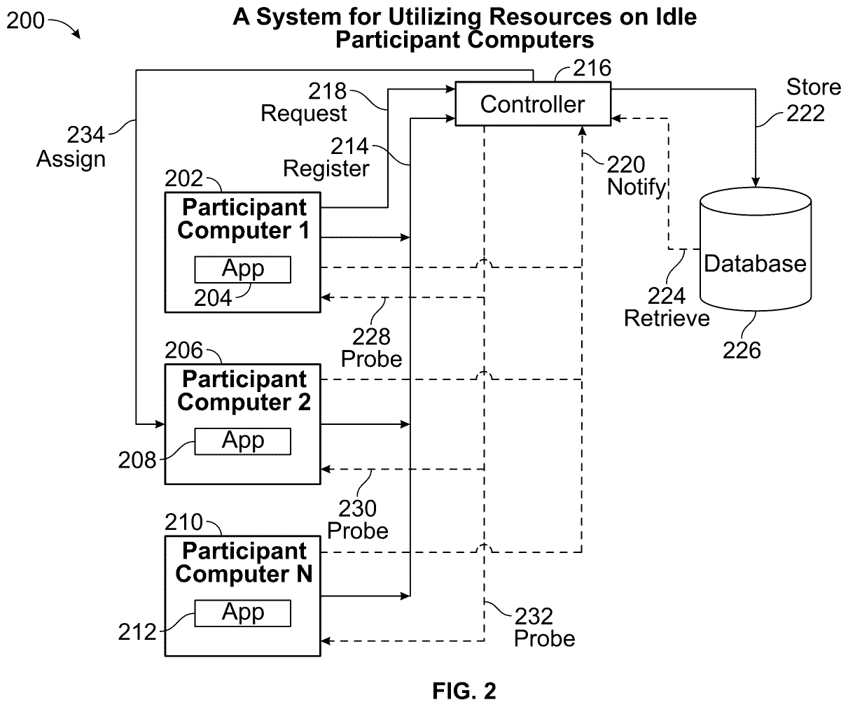

FIG. 2 shows a computer-enabled system 200, within a media production environment (not shown), composted of a controller (a computer program) 216 and a database or the like 226. When a number of collaborator computers (202, 206, 210) get registered (214) into the media production environment, the registration process is through the controller 216, which pushes an app to each of the collaborator computers (app 204 onto computer 202, app 208 onto computer 206, and app 212 onto computer 210), and then the respective registration information is stored (222) onto the database 226. The functions of the installed apps (204, 208, and 212) are to survey the computing resources (software modules installed, hardware modules (input/output devices, storage devices, etc.), network bandwidth) of the hosting computers (202, 206, and 210). The survey data is also stored onto the database 226, via the controller 216. Once the registration and survey are completed, the collaborator computers 202, 206, and 210 become participant computers 202, 206, and 210. It is noted that since not all collaborators, in a media production environment, wish their computers to participating resource-sharing scheme, not all collaborator computers are participant computers.

When a participant computer (such as 202) needs extra resource to compete a media production task assigned to it (e.g., its own resources isn't sufficient to complete the assigned task), it issues a resource request 218 to the controller 216. The resource request includes the name of the participant computer (in this case, 202), and the description of the resource needed. The controller 216, upon receiving the resource request 218, retrieves (224) information from the database 226 by using the resource request.

Upon receiving the retrieved information about the names of the participant computers that match the resource request (i.e., the participant computer has the resource matching the description of requested resource), the controller sends probes (228, 230, and 232) to each of the participant computers contained in the retrieved information, via apps installed thereon. The respective app on each participant computers being probed (e.g., computers 206 and 210) then survey the requested resource's status, and notify 220 the controller 216 about the status of the requested.

The controller 216, upon receiving notifications from all probed participant computers, choose one of the computers that has an idle requested resource (e.g., participant computer 206), to let the requesting computer 202 communicate with the request-fulfilling computer 206 to collaborate via their respective apps (204 and 208), to let computer 202 to utilize the idled resource on computer 206.

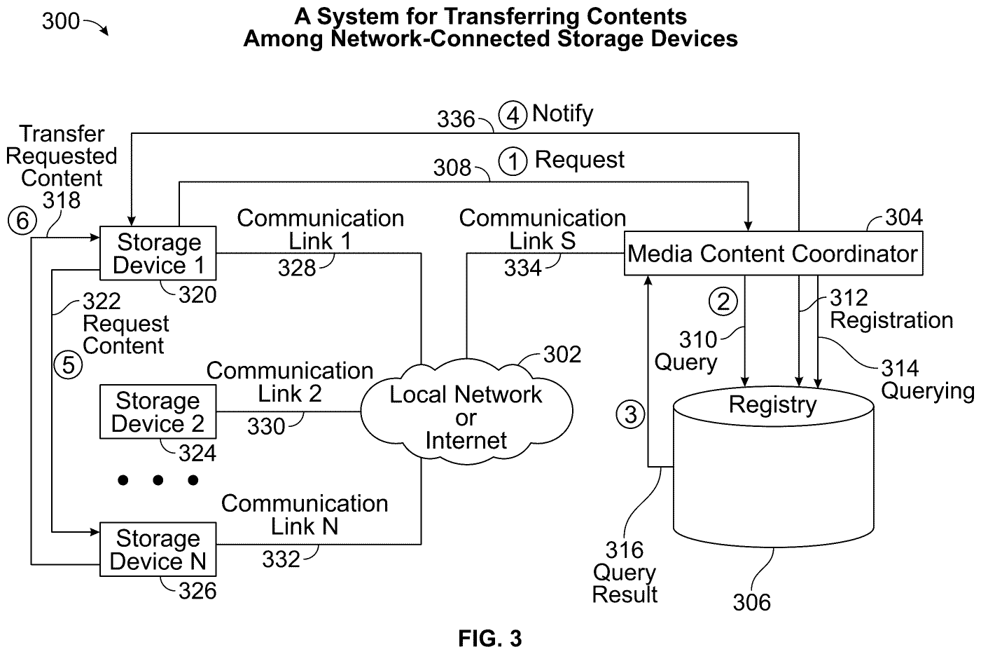

Similar to resource sharing scheme depicted in FIG. 2, media stored on networked storage devices in a media production environment can be shared and transferred as shown in FIG. 3.

Referring to FIG. 3, in the setup 300, A media content coordinator 304 (a software module running on a computer) is communicatively connected to a number of disparate networked storage devices 320, 324, and 326 via a local network or the Internet 302. The coordinator 304 also accesses (registering 312 or querying 314) a Registry 306, which can be a database or the like in the media production environment.

Upon a new networked storage device admitting to the setup of 300, the device (such as 320, 324, or 326) is registered, via the media content coordinator 304, to the Registry 306. The registration 312 thereof entails registering the address of the device on the network of the device, and the description and location of each content fragment (i.e., media asset) stored on the device. Note, a storage device may contain multiple content fragments (such as images, videos, and audios, and the mixture thereof). Only registered storage devices can participate the content-sharing system.

When a registered storage device (such as the storage device 1 (320)) needs a media content fragment, it issues a request 308 including the description of the requested media content fragment and the name of the registered storage device to the media content coordinator 304, which in turn queries 310 the Registry 306 via the querying operation 314. The Registry 306 transmits the query result 316 to the media content coordinator 304, and the result 316 may contain one or more locations where the requested content fragment is located. The coordinator 304 chooses at least one of the locations and notify the requesting device 320 about the location (e.g., a location on the storage device N). The requesting device 320 then sending a content request to the request-fulfilling device (e.g., the storage device N), which in turn opens an access for the requesting device 320 to transfer or read the requested content 318.

It is noted that transferring the requested content fragment from one device to another can be in many forms. For example, the requested content fragment can be copied to the target device, or can be streaming to the target device, or can be previewed in thumbnails, etc.

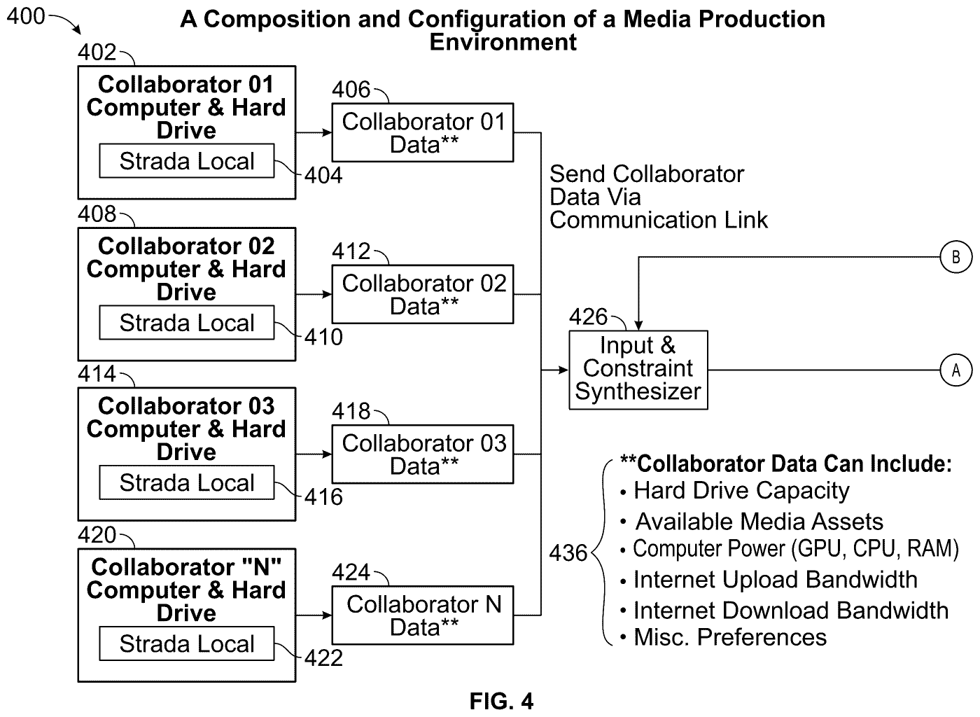

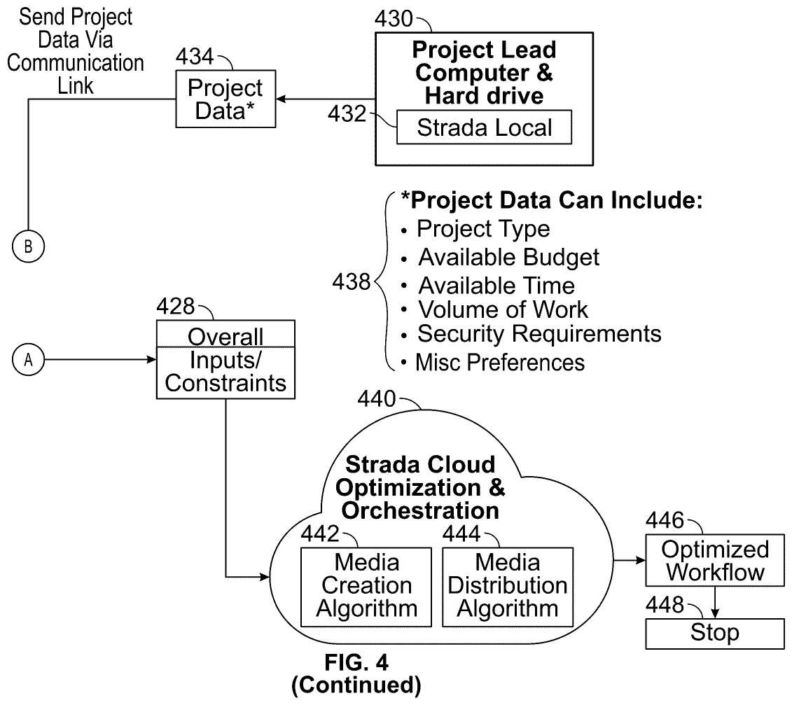

Referring to FIG. 4, it shows a composition and configuration of a media production environment of one embodiment. Variations may occur in various embodiments, but the essential idea of the composition and configuration remains the same as shown in FIG. 4. The media production environment 400 contains a number of Collaborator Computer & Hard drives (402, 408, 414, 420), a project Lead Computer & Hard drive (430), a Strada Cloud (440) which carries on Optimization & Orchestration. On each of Collaborator Computer and the Project Lead Computer, there is a Strada Local installed, and the Strada Local is a software module that coordinates the computers and the Strada Cloud into the media production environment, and the Strada is the operating system that operates the media production environment and coordinates activities within the environment. The Input & Constraint Synthesizer 426 is a software module and a part of Strada as well, and it may be hosted on the Project Lead Computer, or a different computer, or in the Strada Cloud. Each of the Collaborator Computer & Hard drives and the Project Lead Computer & Hard drives may store one or more media content fragments, and these devices are the disparate networked storage devices as shown in FIG. 3. It is noted that both a Strada system comprises a Strada Cloud and a number of Strada Locals, and the Cloud and the Locals interface, interact and cooperate with each other.

The respective Strada Locals (404, 410, 416, and 422) installed on Collaborator Computer & Hard drives (402, 408, 414, and 420) collect their respective hosting computers and hard drives to produce respective Collaborator Data (406, 412, 418, and 424). A Collaborator Data is a set of data describing the resources and configurations on a Collaborator's Computer as shown in 436, and the Data includes: hard drive capacity, available media assets (i.e., available media content fragments), computer power (GPU, CPU, RAM), Internet upload bandwidth, Internet download bandwidth, software modules, and other miscellaneous preferences such as hard drive configurations, bios versions, etc. Similarly, Project Lead's Computer & Hard drive 430′s Project Data 434, is a set of data describing the resources and configurations on a Collaborator's Computer as shown in 436, and the Project Data includes: hard drive capacity, available media assets (i.e., available media content fragments), computer power (GPU, CPU, RAM), Internet upload bandwidth, Internet download bandwidth, software modules, and other miscellaneous preferences such as hard drive configurations, bios versions, etc. In addition, the Project Data, as shown in 438, include data about a project, such as: project type, available budget, available time, volume of work, security requirements, and miscellaneous preferences about the project.

Via Input & Constraint Synthesizer 426, collaborator data (406, 412, 418, and 424) and project data 434 are synthesized to an overall inputs/constraints (428), which is used by Strada Cloud 440 to produce optimized workflow 446. The process of producing an optimized workflow stops at 448. Strada Cloud 440 has, among other modules, media creation algorithm 442, and media distribution algorithm 444, and implicitly, it has workflow optimization module (not shown). The workflow optimization module analyzes the overall inputs/constraints 428 to divide a media production project into a number of portions that fit with the profiles of the collaborator computers & hard drives so that the collaborators by using their respective computer and hard drive can carry on the portion in a collaborative way, and the optimization plan also takes into considerations of the project data that specifies the budget, time, and other characteristics of the project to make sure the project divide/distribution plan fits with all of the project constraints.

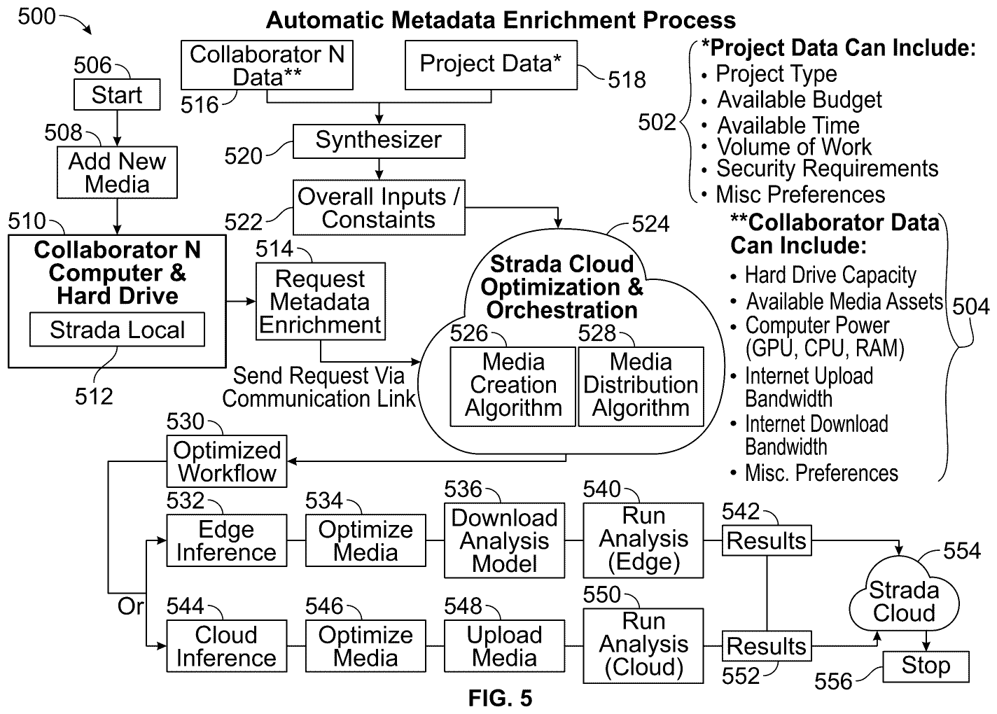

Referring to FIG. 5, a scenario 500 of processing a newly admitted media content fragment to add metadata to the fragment. A metadata of a media content fragment describes most (if not all) characteristics of the fragment. For example, a video clip that depicts two persons (a male and a female) having a conversation over coffees in a kitchen. Then the metadata thereof may include descriptive tags of persons, coffees, kitchen, male, and female. In general, metadata may include but not limited to visual tags, face detection, text detection, emotion detection, object detection, transcriptions of audio, translation of audio. Metadata are used for navigation among media assets and search among media assets, and metadata can be used to optimize the intended result of operations upon media assets such as streaming, rendition, or virtualization in conforming computer's infrastructure constraints and a project's budget-cost-preference constraints, or any user-defined or system-defined constraints.

As shown in FIG. 4, an input & constraints synthesizer 520 synthesizes Collaborator Data 516 (its contents are shown in 504) and Project Data 518 (its contents are shown in 502) and produces an overall inputs/constraint 522, which in turn is fed to the Strada Cloud 524 (which includes, among other modules, Media Creation Algorithm 526 and Media Distribution Algorithm 528.)

The metadata enrichment process begins with 506, and then takes in a new media content fragment (508 on a collaborator computer & hard drive 510), the collaborator computer, via Strada Local 512 installed thereon, requests metadata enrichment upon the newly added media (514). The request is issued to Strada Cloud 524. The request includes at least the location (within the media production environment) of the newly admitted media content fragment.

Upon receiving the request, the Cloud 524 creates an optimized workflow 530 based on the overall inputs/constraints 522. Depending on the nature of the optimized workflow 530, two routes of carrying on the optimized workflow are possible. One is to carry on the optimized workflow on a local collaborator computer & hard drive, namely the collaborator computer & hard drive 510 on which the new media content fragment is added (see 508) and from which the enrichment request is issued (see 514). In this route, the workflow begins with an edge inference 532 (using computer vision models to analyze the media content fragment and make predictions) on the computer & hard drive 510. Then, the media content fragment is optimized 534 (such as removing noises therein). The next step is downloading an analysis model from Strada Cloud to the edge (i.e., computer & hard drive 510), which is followed by running the analysis on the media content fragment (540) on the edge, to produce enrichment results 540. The enrichment results 540 encompass all of the salient features of the media content fragment, and collectively the results 540 are encapsulated in metadata which is then stored in Strada Cloud 554 (which is the same entity of 524). The implementations of storing the metadata can vary depending on the configuration of the Cloud. In a general sense, the metadata is stored in a registry or the like in a form of an association of the media content fragment's identifier and the metadata in a queryable way.

In another route wherein the optimized workflow is meant to be carried on the cloud, the workflow begins with a cloud-based inference 544 (i.e., conducting the media inference in the cloud as opposed on a local edge device 534). Upon uploading the media content fragment to the cloud (548), the cloud runs an analysis 550, and produces the enrichment results 552 which encompass all of the salient characteristics of the media content fragment.

Analyzing a media content fragment for the purpose of finding all of its characteristics involves pattern recognition, feature extraction, and pattern inference (for example, inferring the mood of the people in a scene and the overall social atmosphere in a scene), some of which rely on artificial intelligence that is built on training of historic data.

Once the enrichment process concludes at 556, the newly admitted data added on a local computer 510 is registered and metadata enriched in the cloud 524/544, and although the newly admitted data is physically stored on 510, it can be retrieved in the media production environment via the cloud 524/544 as if it is centrally stored in the Cloud.

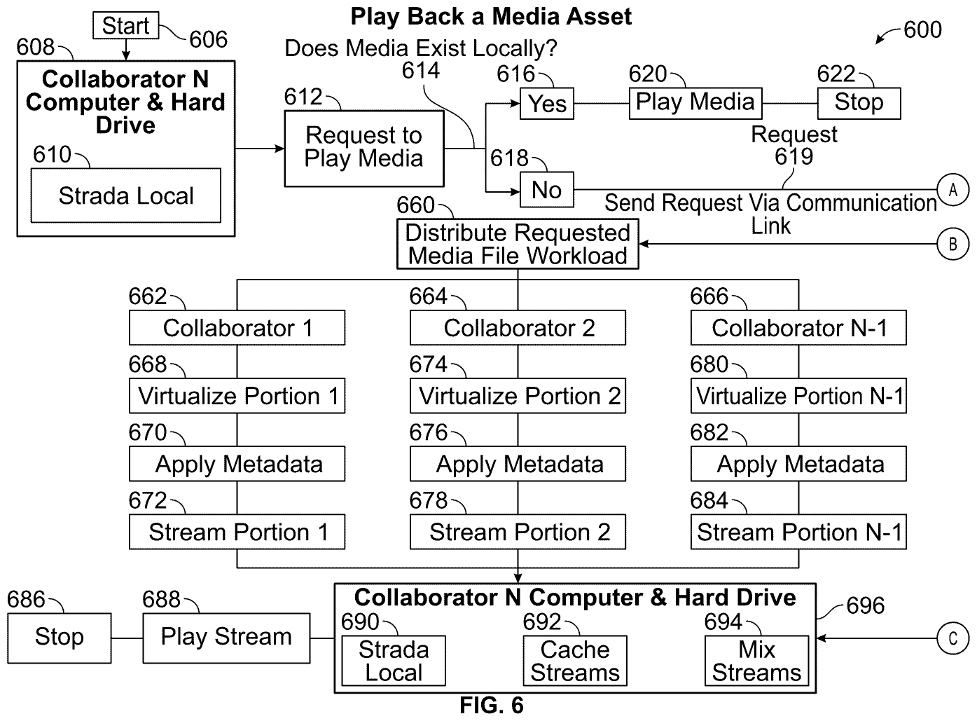

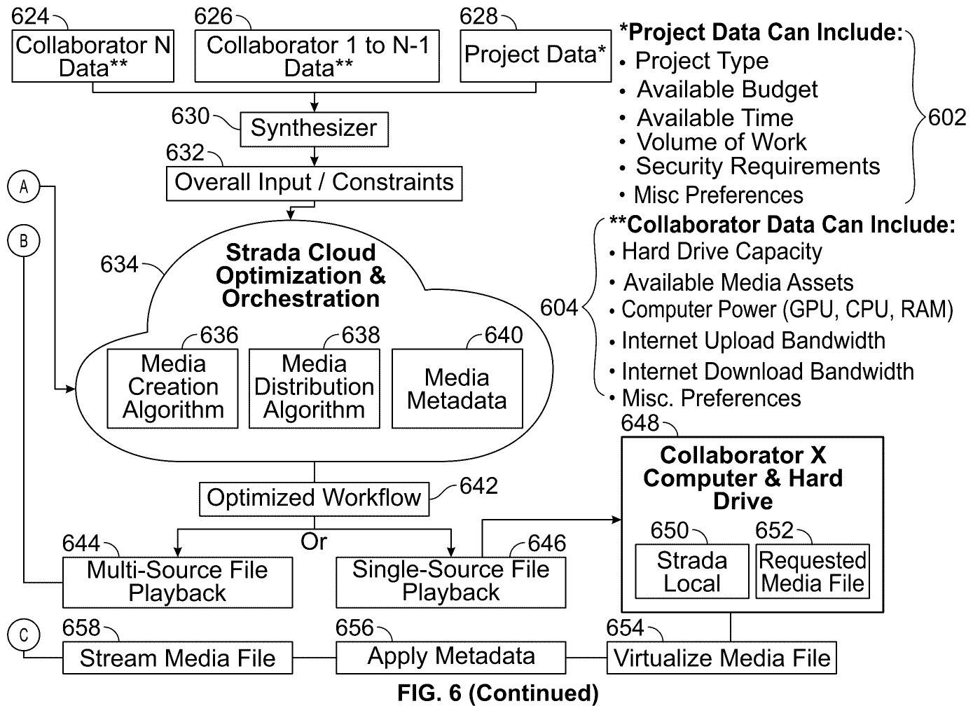

Referring to FIG. 6, a process of playing back a media asset (for a media content fragment) is schematically shown.

In a media production environment 600, as described in the previous figures, Strada Coud 634 takes in the overall inputs/constraints 632 synthesized by the synthesizer 630 based on the collaborator data 604 collected from all collaborator computers including 624, 626 628, and 648, and the project data 602 collected from the project lead computer (not shown). The cloud 634, having, among other modules, media creation algorithm 636, media distribution algorithm 638, and media metadata 640 (which is collected by a process depicted in FIG. 5), works on the overall inputs/constraints 632 and a play-back request 619 to produce (by taking into considerations of 632 and 619) an optimized workflow 642 for fulfilling the request.

The request 619 is originated from a request process beginning with 606, where a collaborator computer & hard drive 608 (which has Strada Local 610 installed) issues a request to play media 612 (which specifies a media content fragment to be played back). Strada local 610 on the computer 608 then determines (614) whether the media exists locally on 608. If the determination is positive (616), then the local computer 608 plays back the media locally, and the process concludes at 622. Otherwise (618), the playing-back request is sent to the Cloud 634 via a communication link (619).

Before the optimized workflow 642 is carried through,, the Cloud determines, according to the optimized workflow 642, whether the media is meant to be streaming from a single collaborator computer or from multiple collaborator computers collaboratively. The decision to go with 646 vs. 644 is about the most optimized way to get the file to action 696. The single file can be provided via path involving the single-sourced route 646, or it can be “crowd-sourced” (or received via a bit torrent like experience) via path involving the multiple-sourced route 644. In a solution like 644, each collaborator (662, 664, 666) each provide tiny pieces of the overall file. 696 combines those pieces together so it acts as a single stream. In some alternative embodiments, the choice between using 644 or 646 can be made based on the metadata associated with the media stored in Media Metadata 640 (i.e., a registry for metadata of all admitted media content fragments, as explained in FIG. 5). If the media asset being requested is a single-source file, then a single-source file playback route (646) is taken.

In this route, Collaborator X's computer & hard drive (648) is located, via the metadata associated with the media being requested (the metadata includes the location of the media, and in this case, the requested media is determined to reside on 648). Strada Local 650 retrieves the requested media file 652 to virtualize the media file 654 (note: virtualization of media is to use software to create virtual representations of physical media assets. This can help media companies improve efficiency, reduce costs, and provide better services.) while applying the metadata associated with the requested media (656) (note, Strada Local 650 receives the relevant metadata from Strada Cloud 634) to the virtual rendition of the requested media, to streaming the virtualization to Collaborator N's computer & hard driver (696, the play-back requester). Computer 696, upon receiving the stream 658 via its Strada Local 690, play the stream 688, and the process concludes at 686.

In another route wherein the media asset is determined to be streamed collaboratively from multiple collaborator computers in order to have an optimal speed (or, alternatively, the media asset is packed in multiple files), the multi-source file playback route 644 is taken. Strada Cloud 634, in the optimized workflow 642, specifies a distribution plan wherein each file of the media's multiple constituent files is streamed on its respective hosting machines (in this case, computers 662, 664 and 666, as the constituent files of the requested media asset have their location known via the metadata associated with the requested media asset). The optimized workflow 642 is then distributed (660) to computers 662, 664, and 666, which, respectively, carries on their respective share of rendition of the respective portion of the requested media asset via the respective flow of virtualization (668, 674, and 680), applying respective metadata (670, 676, and 682), and streaming the respective portion (672, 678, and 684), which are similar to the flow of 654 to 656 and 658. The streams are sent to the requester 696 (i.e., 608), which in turn, via its Strada Local 690, caches the received streams (692), and mix them together (694) according to the metadata of each portion of the media (timelines, in particular) to make sure the playing-backs of the multiple streams are in-sync with each other. The mixed stream then is played back 688 on the computer 696, and the flow concludes on 686.

FIG. 6 demonstrates a parallelization of a media-playback task within a media production environment, and it is obvious that the parallelization speeds up the playing back because the parallelization eliminates the needs for relocation media files across the network, reducing the impact of the network traffic on the performance of the task.

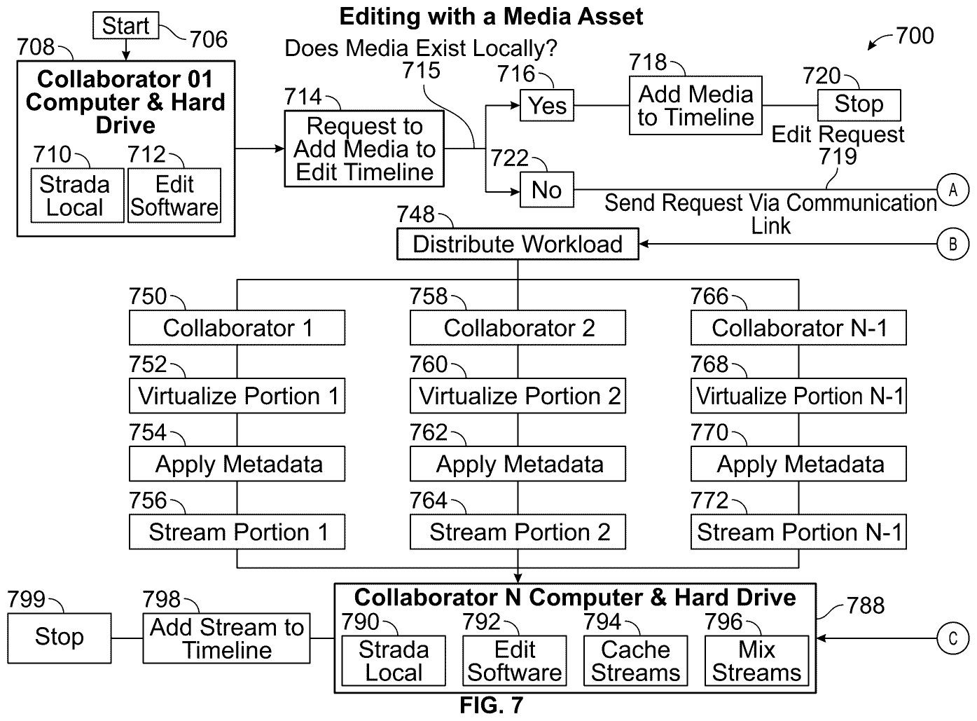

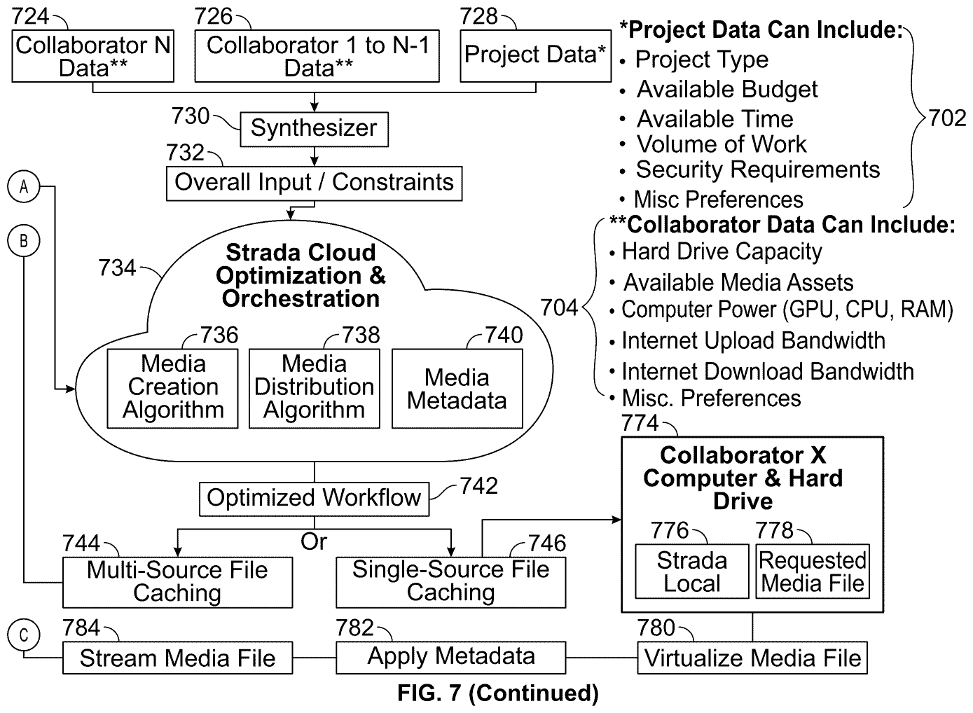

Referring to FIG. 7, a process of editing a media asset (i.e., a media content fragment) is schematically shown.

In a media production environment 700, as described in the previous figures, Strada Cloud 734 takes in the overall inputs/constraints 732 synthesized by the synthesizer 730 based on the collaborator data 704 collected from all collaborator computers including 750, 758, 766, and 774, and the project data 702 collected from the project lead computer (not shown). The Cloud 734, having, among other modules, media creation algorithm 736, media distribution algorithm 738, and media metadata 740 (which is collected by a process depicted in FIG. 5), works on the overall inputs/constraints 732 and an edit request 719 to produce (by taking into considerations of 732 and 719) an optimized workflow 742 for fulfilling the request.

The request 719 is originated from a request process beginning with 706, where a collaborator computer & hard drive 708 (which has Strada Local 710 and an Edit software 712 installed) issues a request to add a particular media asset to an existing timeline (effectively, a request to edit the existing timeline) (714). Strada Local 710 on the computer 708 then determines (715) whether the media asset exists locally on 708. If the determination is positive (716), then the local computer 708 adds the media asset to an existing timeline (effectively changing the existing timeline) (718) and the locally editing concludes at 720. Otherwise (722), an Edit request is sent to the Cloud 734 via a communication link (719).

Before the optimized workflow 742 is carried through, the cloud determines, according to the optimized workflow 742, whether the task is meant to be carried on from a single collaborator computer or from multiple collaborator computers collaboratively. The decision to go with 746 vs. 744 is about the most optimized way to get the file to action 798. The single file can be provided via path involving the single-sourced route 746, or it can be “crowd-sourced” (or received via a bit torrent like experience) via a path involving the multiple-sourced route 744. In a solution like 744, each collaborator (750, 758, 766) each provide tiny pieces of the overall file. 796 combines those pieces together so it acts as a single stream. In some embodiments, the choice between 744 and 746 can be made based on the metadata associated with the media asset which is stored in Media Metadata 740 (i.e., a registry for metadata of all admitted media content fragments, as explained in FIG. 5). If the media being requested is a single-source file, then a single-source file playback route (746) is taken.

When the route 746 is taken, Collaborator X′s computer & hard drive (744) is located, via the metadata associated to the media asset being requested to edit (the metadata includes the location of the media, and in this case, the requested media is determined to reside on 774). Strada Local 776 retrieves the requested media asset file 778. After retrieving the media asset file, there is a streaming process via virtualized rendition is carried through steps of 780, 782, to the requestor 788 (note: virtualization of a media is to use software to create virtual representations of physical media assets. This can help media companies improve efficiency, reduce costs, and provide better services.) while applying the metadata associated with the requested media (782) (note, Strada Local 776 receives the relevant metadata from Strada Cloud 734) to the virtual rendition of the requested media, to streaming the virtualization to Collaborator N′s computer & hard drive (788, the edit requester). Computer 788, upon receiving the stream 784 via its Strada Local 776, adds the stream to the existing timeline 798, and the process concludes at 799.

In another route wherein the media asset is determined to go through the multi-source file editing route 744, Strada Cloud 734, in the optimized workflow 742, specifies a distribution plan wherein each file of the media's multiple constituent files is streamed on its respective hosting machines (in this case, computers 750, 758 and 766, as the constituent files of the requested media have their location known via the metadata associated with the requested media). The optimized workflow 742 is then distributed (748) to computers 750, 758, and 766, which, respectively, carries on their respective share of rendition of the respective portion of the requested media via the respective flow of virtualization (752, 760, and 768), applying respective metadata (754, 762, and 770), and streaming the respective portion (756, 764, and 772), which are similar to the steps of 780, 782 and 784. The streams are sent to the requester 788 (i.e., 708), which in turn, via its Strada Local 790, caches the received streams 794, and mix them together (796) according to the metadata of each portion of the media (timelines, in particular) to make sure the playing-back of the multiple streams is in-sync with each other. The mixing of streams produces a mixed stream, and the mixed stream is added to the existing timeline 798 via the Edit software 792 on the computer 788, and the flow concludes on 799.

FIG. 7 demonstrates another example of parallelization (parallelization of a media-editing task) within a media production environment, and it is obvious that the parallelization speeds up the task because the parallelization eliminates the needs for transferring media files across the network, reducing the impact of the network traffic on the performance of the task.

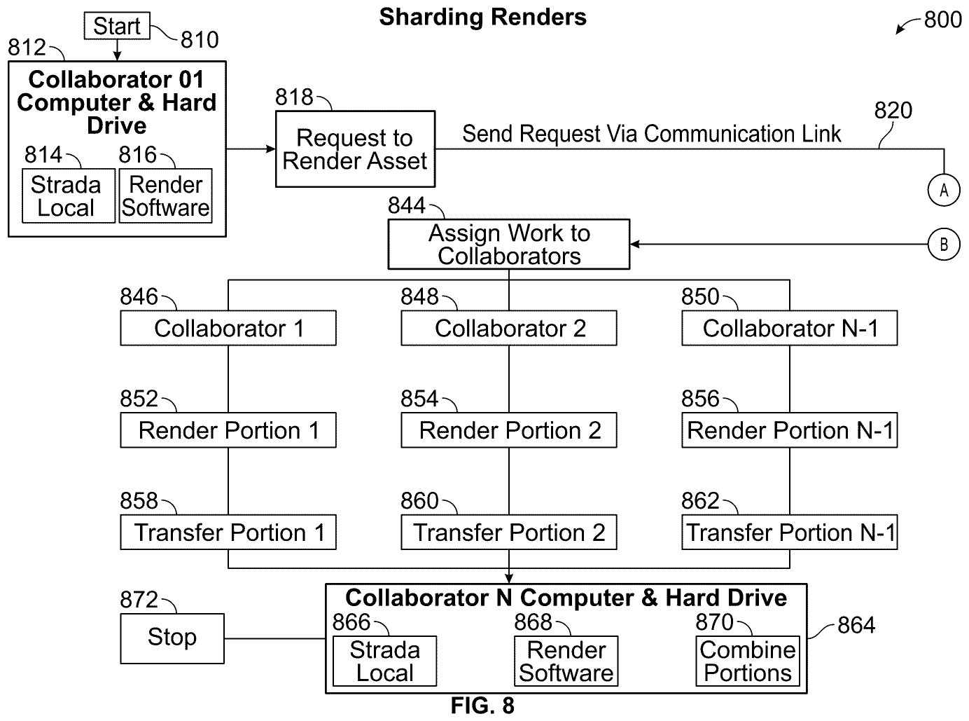

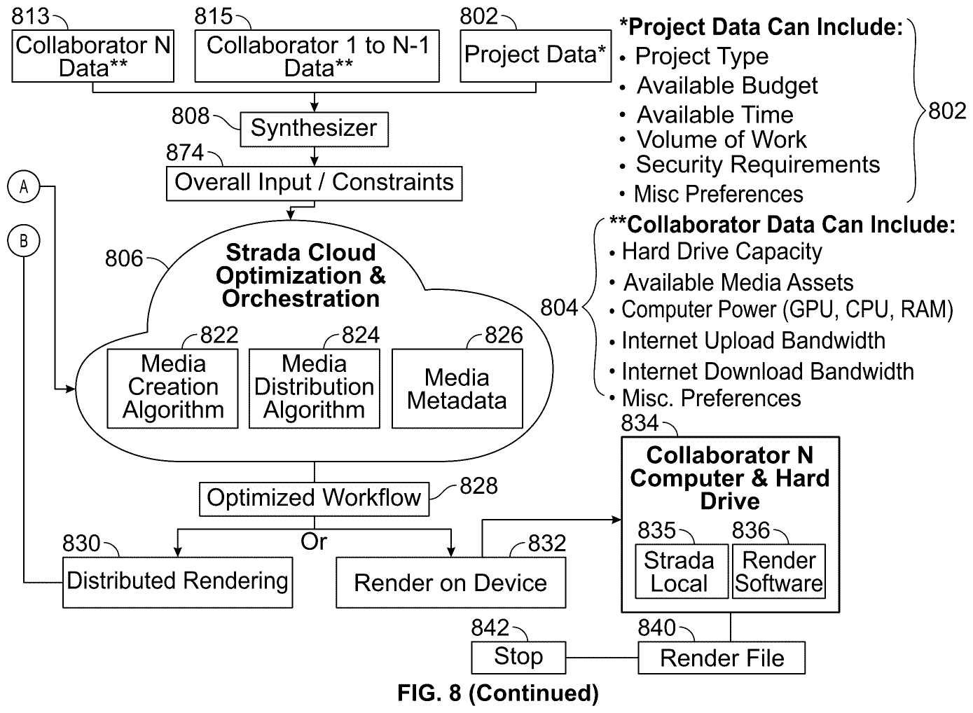

Referring to FIG. 8, a process of sharding renders of a media asset is schematically shown. It is noted that media rendition is the process of creating multiple versions of a media file, such as a video or image, to adapt it to different devices and platforms, and/or to create a single end-result from various input (effectively, “baking in” layers to create a final element). Renditions can be used to improve the viewing experience for users, and to make it easier to edit and post-produce media.

In a media production environment 800, as described in the previous figures, Strada Cloud 806 takes in the overall inputs/constraints 874 synthesized by the synthesizer 808 based on the collaborator data 813 and 815, collected from all collaborator computers including 812 (i.e., 834), 846, 848, and 850, and the project data 802 collected from the project lead computer (not shown). The Cloud 806, having, among other modules, media creation algorithm 822, media distribution algorithm 824, and media metadata 826 (which is collected by a process depicted in FIG. 5), works on the overall inputs/constraints 874 and a rendition request 820 to produce (by taking into considerations of 974 and 820) an optimized workflow 828 for fulfilling the request.

The request 820 is originated from a request process beginning with 810, where a collaborator computer & hard drive 812 (which has a Strada Local 814 and a Render software 816 installed) issues a request to render a media asset (818), which is sent to 806 via a communication link (820). Strada Local 710 on the computer 708 then determines (715) whether the media asset exists locally on 708. Strada Cloud 806, upon receiving the request, works on the request in junction with the overall inputs/constraints 874, by using its modules of 822 (media creation algorithm 822), 824 (media distribution algorithm) and media metadata 826, to produce an optimized workflow 828, by taking into accounts of the overall inputs/constraints 874, and media metadata 826, and the experiences extracted from a number of previously executed workflows via 822 and 824.

Prior to dispatching the optimized workflow 828, the Cloud 806 decides whether the workflow 828 is better suited for rendering on device 832 or rendering, in a distributive way 830, on a number of devices. If it is 832, the workflow is dispatched to a single collaborator computer & hard drive 834 (which has the most fitting profile to the optimized workflow) via Strada Local 835 installed thereon. The render software 836 installed on 834 then renders the file(s) of the media asset 840, and the process stops at 842. It is noted that the media asset being requested for rendition may or may not physically reside on computer 834. It the case when the asset does not reside on computer 834 to be used to make the rendition, the computer may have to obtain the asset via the Cloud first through either asset transferring (downloading) or asset virtualization.

In most cases, for the sake of speeding up the rendition of the media asset to be rendered, the route 830 (distributive rendition) is taken. The distributive rendition starts with 844 which is to assign portions of the rendition to a number of collaborators (the optimized workflow has the plan of dividing the rendition into a number of portions). Collaborators 846, 848 and 850 each, according to the plan, obtain their respective portions of rendition. Each of the collaborators then renders their respective portions (852, 854, and 856), and then transfers (858, 860, and 862) their respective rendered portions to a collaborator 864 (which has its Strada Local 866, Render Software 868, and software for combining portions 870). 864 uses its software modules to combine the rendered portions received from 846, 848 and 850 into a combined rendition for the media asset to be rendered. And the process ends at 872. It is noted that the portions of the media asset being requested for rendition may or may not physically reside on computers 846, 848, or 850. In the case when the portion does not reside on its respective assigned computer to be used to make the rendition, the computer may have to obtain the portion of the asset via the Cloud first through either asset transferring (downloading) or asset virtualization.

To sum up, the Strada first understands the availability & capability of each collaborator's computing infrastructure “Node” (for utilization by other collaborators) and offers a financial incentive for lending computing infrastructure. Strada then distributes the Render process across the network of available Nodes for the specific Render, ensuring that the collaborators who control the individual Nodes are unable to see/access/influence the portion of the Render being completed on their Node. The Strada technology then compiles the various portions of the renders-which were completed on individual Nodes-and assembles the final Render at the destination designated by the Creator. This sharding & rendering process and quality of service takes into account the user-defined and system-defined constraints of the Creator and collaborator to optimize the rendering experience.

FIG. 8 demonstrates yet another example of parallelization of a task within a media production environment, and it is obvious that the parallelization, in this case, speeds up the rendition of a media asset (which is often big in size) by sharding the asset into a number of smaller-sized assets, and thus making the rendition of the multiple smaller-sized assets faster, utilizing a number of computers to carry on the rendition in parallel, saving the time.

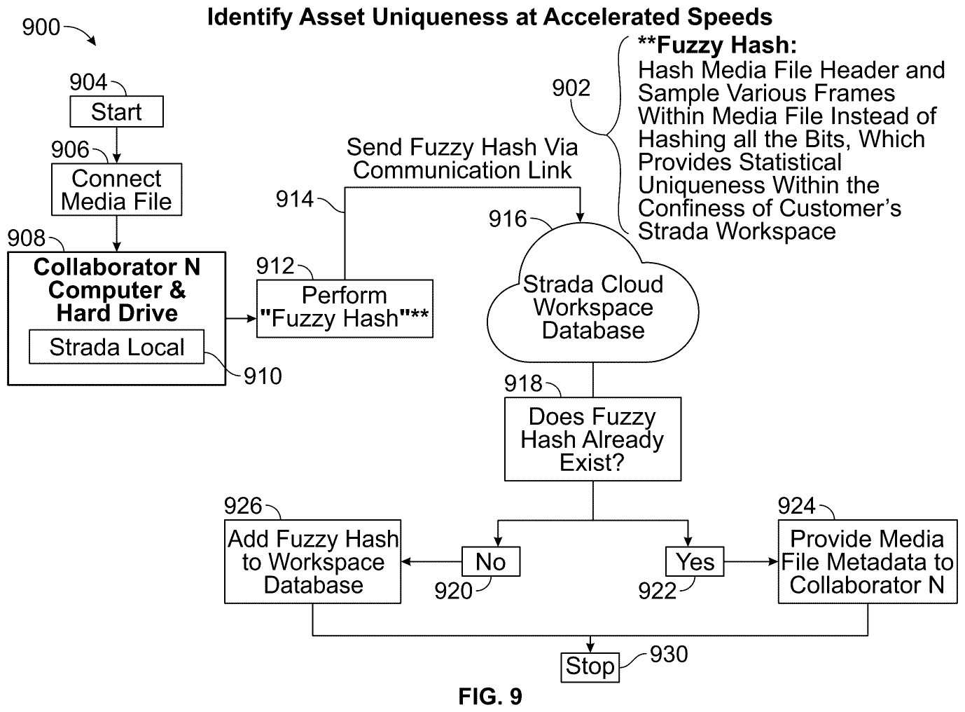

Referring to FIG. 9, it shows within a media production environment a process of identifying media asset uniqueness at accelerated speeds.

The process starts with 904, and connects a collaborator computer & hard drive 908 (having Strada Local 910 installed thereon) to a media asset (or a media file) 906. 908 then conducts fuzzy hashing (912) on the media asset via Strada Local to produce a fuzzy hash for the asset. Fuzzy hashing aims to create very similar hashes for very similar assets. The similarity between any two fuzzy hashes is defined through a distance metric (e.g. the Euclidean distances), and different fuzzy hashing functions may require the use of different distance metrics. The goal is to approximate the level of similarity between input files perceived by humans through the distance between/similarity of the fuzzy hashes.

The fuzzy hash is then sent (914) to Strada Cloud 916 via a communication link. The Cloud then checks its workspace database to see if the fuzzy hash of the asset exists in the database 918. If the answer is positive (922), then the metadata associated with the same fuzzy hash (924) is provided to the collaborator computer 908. It's worth highlighting that metadata associated with a unique video asset (visual tags, transcription, notes, comments, facial recognition) is stored in the database. That metadata, like a “side car”, should follow the asset wherever it goes. If the asset/file goes offline, the metadata is not visible. But as soon as the file comes online again, and completes the fuzzy hash test, all the metadata re-appears. If the answer is negative (920), the fuzzy hash is added to the cloud's workspace database 926 so that the newly accessed media asset (in step 906) would be located next time when a query (for a perceptually similar asset) issued to the Cloud. The process concludes on step 930.

FIG. 9 demonstrates an accelerated query for media assets within a media production environment, by summing up the perceptual uniqueness of an input media asset (i.e., fuzzy hashing) to a hash, and using the hash to conduct the query against a database that stores associations of assets and their perceptual uniqueness.

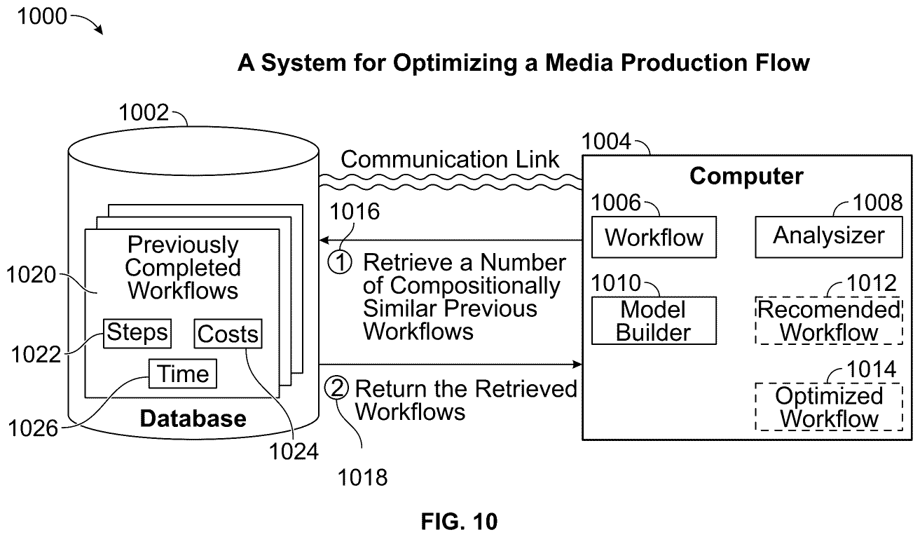

Previous figures (such as FIGS. 6, 7, and 8) mention the Strada Cloud produces an optimized workflow. FIG. 10 schematically demonstrates one way to produce an optimized workflow.

Referring to FIG. 10, the setup 1000 is composed with a database 1002 and a computer 1004, both of which are part of Strada Cloud (not shown), and they are communicatively connected via a communication link. Database 1002 stores a number of previously completed workflows 1020, each of which includes steps 1022 thereof, and cost incurred 1024 and time consumed 1026 associated with the entire workflow. The computer 1004, on the other hand, includes an Analysizer 1008 which is a software module, and a Model Builder 1010 which is a software module.

Upon receiving a workflow 1006, the computer retrieves a number of previously completed workflows from database 1002 that are compositionally similar to the workflow 1006. A workflow (WF1) is compositionally similar to another (WF2) means the steps contained in WFI are same as or similar to the steps contained in WF2. After the database 1002 returns the retrieved workflows (1018) to the computer 1004, the computer analyzes, by using Analysizer 1008, the retrieved workflows, to find out the correlations between the orders of the constituent steps of the previously completed workflows and the time-consumed and the cost-incurred. Using the discovered correlations, the model builder builds an optimization model. The computer then runs the workflow 1006 through the optimization model to produce a recommended workflow, so that the recommended workflow not only is compositionally similar to the workflow 1006, but also incurs the least possible cost and consumes the least possible time when it is executed. Lastly, the computer re-arranges the order of the steps of the workflow 1006, according to the recommended workflow 1012 to produce an optimized workflow 1014. This step is necessary, because the recommended workflow 1012 is not necessarily identical to the workflow 1006, so that re-arranging the steps of the workflow 1006 according to the spirit of (as to the letters) the recommended workflow 1012 is the essence. In the end, it is the optimized workflow 1014 that is distributed by Strada Cloud to one or more collaborator computers to execute.

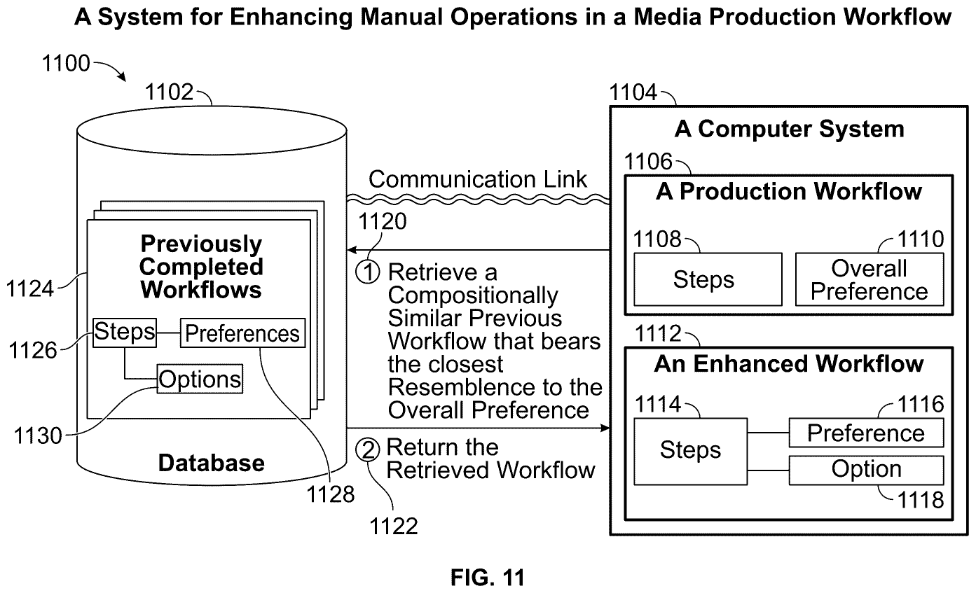

Referring to FIG. 11, a diagram schematically illustrates a system and steps for enhancing manual operations in a media production workflow. In a workflow, there are some manually operated steps (such as fine-tuning the colors of video footages), and these manually operated steps often cost time in setting operational options and preferences thereof. Therefore, one way to speed up these manually operated steps is to set these otherwise manually set operational options and preferences by the computer. In order to properly set the operational options and preferences of these manually operated steps, the computer needs to obtain the proper settings from somewhere.

The setup 1100 is composed with a database 1102 and a computer 1104, both of which are part of Strada Cloud (not shown), and they are communicatively connected via a communication link. Database 1102 stores a number of previously completed workflows 1124, each of which includes steps 1126 thereof, and preferences used 1128 and operational options used 1130 in each step thereof. The computer 1104, on the other hand, includes an Analysizer (not shown) which is a software module.

Upon receiving a production workflow 1106 which contains a number of steps 1108 and an overall preference 1110, the computer retrieves (1120) a number of previously completed workflows from database 1124 that are compositionally similar to the workflow 1106. A workflow (WF1) is compositionally similar to another (WF2) means the steps contained in WFI are same as or similar to the steps contained in WF2. After the database 1124 returns (1122) the retrieved workflows to the computer 1104, the computer analyzes, by using Analysizer, the retrieved workflows, to find out the overall preference for each of the retrieved previously completed workflows. It is noted an overall preference for a workflow is a preference value that sets an overarching or theme tone of the product of the workflow. For example, if a film's overall preference is a Western vibe, then every detail about the film must conform with a Western vibe (in another word, overall feel of the creative vision of the film project)—aesthetically and acoustically on-point with the vibe. From retrieved previously completed workflows, the computer chooses the one (say, Model_WF) that has an overall preference that is the closest to the overall preference 1110 of the production workflow 1106, to produce an enhanced workflow 1112 in which, each of the step (1114) carries operational options 1118 and preferences 1116 are same as the respective operational options and preferences in Model_WF. Then, the enhanced workflow 1112 is ready to be executed, without human interferences. Since a lot of time would be spent on manually setting the operational options and preference, the automatic setting of the options and preferences with a set of options and preferences that are technologically discovered would save a lot of time of executing a production workflow.

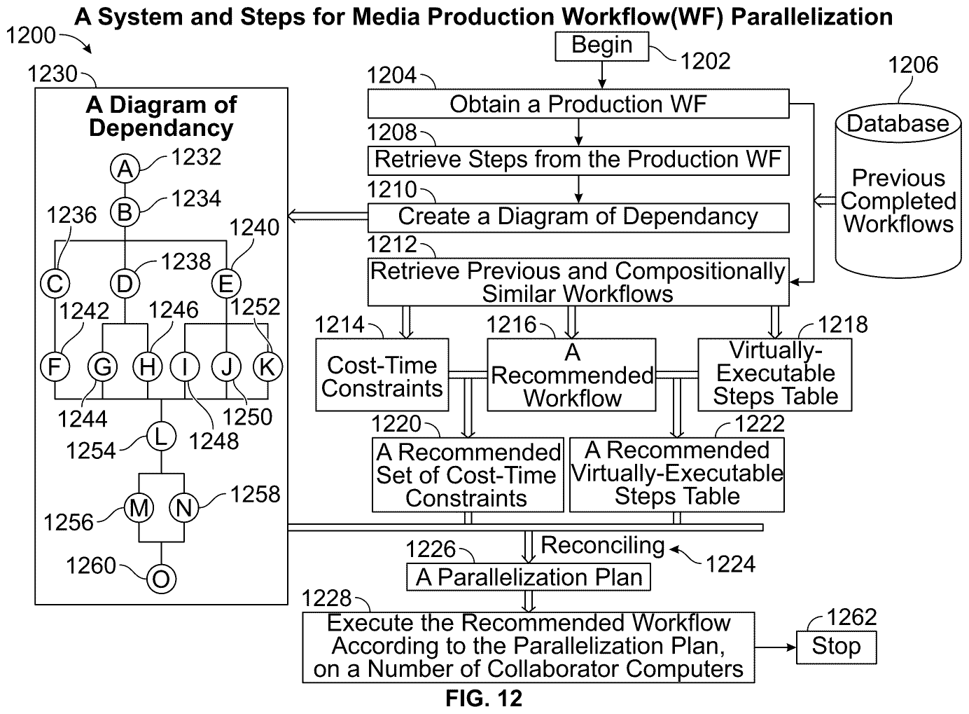

FIGS. 6, 7, and 8 show an optimized workflow is executed parallelly on a number of collaborator computers. That is to say the optimized workflow has a parallelization plan facilitation the parallel execution. FIG. 12 demonstrates how a parallelization plan is produced.

Referring to FIG. 12, in the setup 1200, a computer (not shown) in a media production environment, executes operations in the steps begins with step 1202. The computer, upon obtaining a production flow 1204, retrieves constituent steps from the production workflow 1208, and then creates a diagram of dependency 1210, by using an Analysizer therein (not shown). A diagram of dependency is depicted in 1230, in which steps A, B, C, . . . . O (labeled as 1232, 1234, 1236, . . . , 1260) as examples are arranged in a connected fashion. The vertical line between steps A 1232 and B 1234 means that step B cannot be started until step A is completed. The vertical line between step M 1256 and step O 1260, the vertical line between step N 1258 and step O 1260 mean step O cannot start until both steps M and N are completed.

The lack of vertical lines among steps C 1236, step D 1238 and step E 1240 means that there are no constraints for the order of executing steps C, D and E. The lack of vertical lines among steps F1242, G1244, M 1246, I 1248, J 1250, and K 1252 means there is no constraint for the order of executing steps F, G, M, I, J, and K. The diagram shows and encodes which steps can be executed at the same time (on different collaborator computers) (those steps that have no executing order constraints among each other), and which steps cannot be executed at the same time and must be executed sequentially (those steps that have executing order constraints among each other).

The computer then retrieves, from a database 1206 storing a number of previously completed workflows, all of the previously completed and compositionally similar workflows 1212, and conduct analysis on the retrieved previously completed workflows, to produce a set of cost-time constraints 1214, a recommended workflow 1216, and a table holding virtually-executable steps 1218.

A set of cost-time constraints 1214 indicates a number of constraints of cost-incurred and time-consumed respective to different configurations of steps in the historic workflows. This set of constraints data specify the cost-time boundary for each of the step configuration.

A recommended workflow 1216 is a previously completed and compositionally similar workflow that incurred the least overall cost and the consumed the least time. Note, in a mathematic term, this recommended workflow represents a global optimization in terms of cost incurred and time consumed, but not necessarily a reginal optimization. In parallelizing a workflow, both reginal optimization and global optimization need to be considered. That is why we need to use the set of cost-time constraints 1214, in addition of the recommended workflow 1216, as well.

The table holding virtually executable steps 1218 is a table to list all virtually executable steps. A virtually executable step is a step that has no constraints upon it when executing because execution thereof is not tied up on the resource of the computer that executes it due to the effect of virtualization of the execution. In other words, for example, if step M 1256 is a virtually-executable step, it can be executed before or at the same time as step 1254, irrespective of the sequential order between step L 1254 and step M in the diagram of dependency 1230. In a sense, the table is an antidote to the diagram of dependency 1230, loosing up some of the dependency requirements specified by the diagram.

The computer then produces a recommended set of cost-time constraints 1220 based on 1214 and 1216, and a recommended virtually-executable steps table 1222 based on 1216 and 1218.

The computer then reconciles 1224 the recommended set of cost-time constraints 1220, the recommended virtually-executable steps table 1222, and the diagram of dependency 1230 to produce a parallelization plan 1226. The reconciliation step 1224 is to take all the information in 1230, 1220 and 1222 to work out an optimal parallelization plan that conforms the sequence constraints specified in the diagram of dependency 1230 with the exception that steps contained in the recommended virtually-executable steps table 1222 which are free of sequence constraints, and that optimally conforms the cost-time constraints specified in the recommended set of cost-time constraints 1220.

The recommended workflow 1216 is then distributed, by Strada Cloud, according to the parallelization plan 1226, to a number of collaborator computers for them to execute their assigned steps of the workflow. The process ends at 1262.

The present invention (Strada) has other features that contribute to the advancements that the invention has made in the field of creative production.

In one embodiment, Strada utilizes AI technology and other proprietary means to analyze a Content creator's creative vision, and based on the specifics of that vision, reverse-engineers viable pathways from which the Content Creator can choose. Each pathway presents a combination of available software solutions and other decisions that will allow the creative vision for the Finalized Project to be produced.

No other marketplace offering presents a thorough inventory of available tools and solutions in the way the embodiments of the invention do, and no other offering does so intelligently. Strada's AI functionality responds to the details of the specific creative vision provided by the Content Creator to provide a menu of options that can actually deliver the desired Finalized Project, without running into dead-end inconsistencies with that envisaged end product.

Strada also ensures that options presented are all compatible with each other, so that time, effort, and money are not wasted in trying to integrate two file types from two systems that are difficult or impossible to reconcile with one another. This invention addresses a key problem in the Content creation process by allowing a Content Creator to see at the outset of a project which combinations are compatible with the creative vision for the Finalized Project. A Content Creator can then embark on a chosen workflow pathway with the comfort that the pathway will indeed lead to the intended destination (i.e., the intended creative vision.)

In one embodiment, Strada enables a Content Creator to plan, prepare, make decisions on solutions, execute the creation of Assets, integrate the Assets, and finalize the Content in accordance with the original creative vision for the Finalized Project, all on a single, user-friendly, integrated platform. The originality of Strada includes its discovery proposition. With the large number of technological solutions available today for various post-production and other Content creation processes (and with that number growing daily), it is an immense challenge for a Content Creator to know (a) what options are available, (b) which of those options are generally superior, (c) which options are most suitable for the specific creative vision of a particular project, and (d) which options are compatible or incompatible with one another. The Strada marketplace on the Strada platform solves this problem by aggregating information about the various third-party offerings available and presenting the information in a one-stop-shop format on the Strada platform. Strada simplifies the otherwise onerous challenge of trying to learn on one's own what solutions exist and what their advantages and disadvantages are. Strada enables a Content Creator to read curated information, see customer reviews, and make a more informed decision. And because the Strada marketplace is designed around an interchangeable architecture, new solutions and recommendations can be updated as they emerge (and new limitations to existing offerings can be pointed out as they surface).

Furthermore, through a variety of business-to-business software license agreements and other business arrangements, Strada allows Content Creators to access such third-party solutions directly on the Strada platform instead of having to navigate multiple individual websites, apps, platforms, and subscriptions. In sum, Strada aggregates, demystifies, and simplifies the Content creation process.

In one embodiment, Strada is a system to orchestrate the processing of Content in a sequence with the constraint that certain tasks must be done before others. As part of processing, the Content can go through numerous steps, including cleansing, aggregation, enrichment, and transformation. These steps may include leveraging third-party technologies or Strada-designed technologies. This configuration, among other benefits, allows for the automatic parallelization of processes where possible, and prevents processing “dead-ends.” A system built on a DAG allows for a scalable system that processes Content as quickly and as efficiently as possible. In other words, a DAG that (a) is defined/designed by the end-user (b) relies on third-party technologies and (c) is orchestrated by another entity is novel.

In another embodiment, Strada has the ability to create “stacks” of disparate Assets as described above, allowing multiple Assets to be viewed simultaneously within a single graphical user interface (GUI). Because of the technology and design of the Strada system, the real-world location of Assets is immaterial to the Strada workflow, thus allowing viewing within the same GUI of Assets stored in different Network-Connected Storage Devices. And if the Content Creator needs to sync playback/viewing of multiple Assets, that process can also be done irrespective of whether the Assets are stored in the same Network-Connected Storage Devices or in different ones.

In one embodiment, Strada is an integrated system that connects with multiple third-party software and storage systems, and Strada recognizes all log-in credentials pertaining to a particular Content Creator across all such applications. Strada is able to recognize the Content Creator as a specific individual, and within that Content Creator's Strada account, Strada amasses all of that Content Creator's various IDs across all integrated third-party applications. This feature is especially useful given that many Content Creators are freelance artists assigned many different email addresses, usernames, etc. by their various clients and employers.

In one embodiment, Strada syncs disparate Assets that share a common real-world moment in time (or are assigned a common moment by the Content Creator). Strada also generates automated transcriptions when any Asset or stack of Assets contains audio. Taken together, these two features allow for a novel and quite useful result: visual Assets that do not contain embedded audio become searchable through their nexus to the related audio files, and therefore transcription of such visual Assets now becomes possible. This possibility can be quite helpful to a diverse set of Content Creators, and has real-time applications for creative professionals working on a television/film set.

In one embodiment, Strada enables a Content Creator to highlight particular text in the Strada-generated transcription, and the audio/visual Assets in the viewing pane automatically jump to the respective location within the relevant Assets. As noted, this feature allows the Content Creator to easily navigate and quickly understand any Asset, even if that Asset does not have audio, as long as there are related audio Assets in the stack.

In one embodiment, for any Asset containing audio with discernable words, the Content Creator has the option in Strada to generate an automatic translation from any language to any other language. The translation happens instantaneously and is delivered on-screen within the Strada platform. If desired, a Content Creator in Strada can simultaneously view multiple synced Assets, a source-language transcription, and a target-language translation, all generated and delivered automatically within the Strada platform. Even if the source language is one that the Content Creator cannot identify, Strada recognizes the source language and provides a translation into whatever target language the Content Creator designates. In combination with the stacking, syncing, and transcription features, Strada allows even Assets that do not contain audio to be translated, via the time-reference link to a related audio Asset.

In one embodiment, Strada analyzes, synthesizes, and then presents to the Content Creator a detailed set of information about the Asset, some technical (e.g., (without limitation), file type, resolution, audio channel configuration, frame rate, codec, color space) and some more content-focused (e.g., (without limitation), which people appear in the Asset, what type of scene it is, what objects are present, the emotions portrayed in the scene, specific locations or events depicted). Some of this analysis is automatic and some is based on the bespoke needs and manual prompts initiated by the Content Creator. Through a single GUI, Strada equips a Content Creator with a treasure trove of data about what is on screen and for how long.

In the embodiment, the power of this feature from Strada comes from the ability of the Content Creator to export any and all of this data for downstream use in the Content creation process. For example, a Content Creator can use this information in a non-linear editor, dramatically streamlining the editing process. All of the data is usable and searchable at all stages of the Content creation process in Strada.

In another embodiment, the use of the Strada marketplace disintermediates software product development and enhances the processes of creating real-world solutions for Content Creators. If a Content Creator has a specific problem in need of a specific solution, they are no longer limited to either finding the closest off-the-shelf proxy solution or engaging in the expensive endeavor of retaining a captive development/engineering team. Rather, the Content Creator can present the situation in the marketplace, which would be viewable by the network of developers and engineers participating in the Strada ecosystem. An interested developer/engineer can then take on the assignment of creating a bespoke and purpose-built solution specifically for the Content Creator in question.

In another embodiment, because of the unique nature of the Strada system, whereby a Content Creator can view, experiment with, and iterate upon existing Assets or Content stored in a Network-Connected Storage Device without altering the original Asset or Content files, Strada also allows for a novel approach to building fine-tuned AI models based on third-party IP. Specifically, situations often arise in which the rights holder to a (subjectively or objectively) valuable IP wishes to develop an AI trained on the IP, or license the IP to train a 3^{rd} party AI model, but is reluctant to give direct control or custody of the IP Assets to the developers/engineers engaged to build the AI model. The Strada process enables the IP rights holder to maintain control and custody over Assets at all times, while leveraging Strada's file virtualization technology to enable developers/engineers to utilize the Assets for AI model-building purposes, but never outright transferring the files. That is to say, Assets are to be accessed via virtualization for fulfilling AI model building & training purposes, and the access via virtualization thereof does not entail physically transferring or copying the Assets from their physical storage locations to anywhere else due to the nature of virtualization, thus the IP rights (if any) associated with the Assets will not be violated, and the process can be completed without first uploading the Assets. In this manner, the IP rights holder can scale the level of access dynamically, thus getting past a key obstacle IP owners face in pursuing AI solutions.

With regards to the seven issues faced by the field of Creative Production that are mentioned in the Background section of the specification, the Strada system provides solutions to each of them. Specifically,

Solution to the issue 1: Strada's technology first enables the Content Owner to automatically enrich the Raw Elements with metadata, without the Content Owner moving the Raw Elements from their original location, generating copies, or creating proxies of the Raw Elements specifically for metadata enrichment. Depending on the user-defined & system-defined constraints of the Content Owner, the metadata enrichment process can occur either using edge-inference AI technologies (e.g., open-source or licensable AI models downloaded from the internet) or cloud-inference AI technologies (e.g., open-source or licensable AI models that operate within hyperscale cloud providers). Strada's technology also is a graphical interface that enables collaborators to search, discover, organize, assemble, edit, and play back the metadata-enriched Raw Elements without the Content Owner moving, generating copies, or creating proxies of the Raw Elements for the collaborators. In other words, the Raw Element remains in place and does not require any pre-processing; the Raw Element is instead streamed to the collaborator via the Strada technology but “behaves” like it is locally stored on the collaborator's device. This streaming process and quality of service takes into account the user-defined and system-defined constraints of the Content Owner and collaborators to optimize the streaming experience.

Solution to issue 2: Strada's technology first allows the Creator to make a certain Version stored on the Creator's computer (or stored on a connected drive) available for the Reviewer to access and play back without direct involvement by the Creator. The ability for the Reviewer to access the Version is not the result of the Version being stored in a centralized location; it's the result of the Strada technology indexing the Version on the Creator's computer and communicating to others (via a Strada interface) that the Version is available for playback. Strada's technology also enables the Reviewer—who has a device equipped with Strada technology—to stream the Version to their respective device(s) and locally cache the specific moments of the Version that are needed for asynchronous playback. The Version “behaves” like it is locally stored on the Reviewer's device. This streaming process and quality of service takes into account the user-defined and system-defined constraints of the Reviewer and Collaborator to optimize the streaming experience.

Solution to issue 3: Strada's technology first allows the collaborator to make a certain Raw Element stored on the collaborator's computer (or stored on a connected drive) available for the Remote Editor to access and leverage in a specialized Legacy Application without direct involvement by the collaborator. The ability for the Remote Editor to access the Raw Element is not the result of the Raw Element being stored in a centralized location; it's the result of the Strada technology indexing the Raw Element on the collaborator's computer and communicating to others (via a Strada interface) that the Raw Element is available to be leveraged by the specialized Legacy Application. Strada's technology also enables the Remote Editor—who has a device equipped with Strada technology—to stream the Raw Element to their respective device(s) and locally cache the moments of the Raw Element that are needed in the specialized Legacy Application. The Strada technology ensures that the Remote Editor does not need a “media relinking” process in order to utilize the Raw Element (whether it's being streamed or cached) in the specialized Legacy Application; the Raw Element “behaves” like it is locally stored on the Remote Editor's device. This streaming and caching process and quality of service takes into account the user-defined and system-defined constraints of the Reviewer and Collaborator to optimize the streaming experience.

Solution to issue 4: The Strada technology first understands the availability & capability of each collaborator's computing infrastructure “Node” (for utilization by other collaborators) and offers a financial incentive for lending computing infrastructure. The Strada technology then distributes the Render process across the network of available Nodes for the specific Render, ensuring that the collaborators who control the individual Nodes are unable to see/access/influence the portion of the Render being completed on their Node. The Strada technology then compiles the various portions of the renders—which were completed on individual Nodes—and assembles the final Render at the destination designated by the Creator. This sharding & rendering process and quality of service takes into account the user-defined and system-defined constraints of the Creator and collaborator to optimize the rendering experience.

Solution to issue 5: Strada's technology first allows the collaborator to make a certain Raw Element stored on the collaborator's computer (or stored on a connected drive) available for the Remote Editor to access and leverage in a specialized Legacy Application without direct involvement by the collaborator. The ability for the Remote Editor to access the Raw Element is not the result of the Raw Element being stored in a centralized location; it's the result of the Strada technology indexing the Raw Element on the collaborator's computer and communicating to others (via a Strada interface) that the Raw Element is available to be leveraged by the specialized Legacy Application. Strada's technology also enables the Remote Editor—who has a device equipped with Strada technology—to stream the Raw Element to their respective device(s) and locally cache the moments of the Raw Element that are needed in the specialized Legacy Application. The Strada technology ensures that the Remote Editor does not need a “media relinking” process in order to utilize the Raw Element (whether it's being streamed or cached) in the specialized Legacy Application; the Raw Element “behaves” like it is locally stored on the Remote Editor's device. Should the Raw Element on the collaborator's computer go offline for a period of time that's shorter than the cache's Time To Live (“TTL”) value on the Remote Editor's device (as determined by the Strada technology), the Strada technology will enable the Remote Editor to utilize the cached version of the Raw Element without disruption. Should the Raw Element remain offline for a period of time that's longer than the cache's TTL value on the Remote editor's device (as determined by the Strada Technology), the Strada technology will designate the Raw Element as “offline.” This streaming and caching process and quality of service takes into account the user-defined and system-defined constraints of the Reviewer and Collaborator to optimize the streaming experience.

Solution to issue 6: Strada's technology enables for near-instant transcoding of the various Raw Elements requested by the collaborator—who has a device equipped with Strada technology—and for the results of the transcoding to be streamed and locally cached by the collaborator. These operations are done in near real-time (i.e., the transcode is delivered right after request). The transcoding could involve, for example, combining 2 x video assets together, applying a color LUT to video, or inserting a watermark. The transcoded & streamed results are ephemeral; the results may be sufficient for the collaborator to make a judgment call, but they are not deemed a newly-created Raw Element. That means the request to view the same result at a future date would require the same transcoding/streaming/caching process. The transcoding, streaming, and caching processes and quality of service takes into account the user-defined and system-defined constraints of the collaborator to optimize the experience.

Solution to issue 7: Strada's technology first enables the collaborator—who has a device equipped with Strada technology—to stream the Raw Element from the Content Owner to their respective device(s) and locally cache the moments of the Raw Element that are needed. The Strada technology ensures that the collaborator does not need a “media relinking” process in order to utilize the Raw Element (whether it's being streamed or cached); the Raw Element “behaves” like it is locally stored on the collaborator's device. Should the Raw Element stored with the Content Owner go offline for a period of time that's shorter than the cache's Time To Live (“TTL”) value on the collaborator's device (as determined by the Strada technology), the Strada technology will enable the collaborator to utilize the cached version of the Raw Element without disruption. Should the Raw Element remain offline for a period of time that's longer than the cache's TTL value on the collaborator's device (as determined by the Strada Technology), the Strada technology will designate the Raw Element as “offline.” Once the Raw Element is re-connected from an offline state, the Strada technology performs a proprietary hashing process—consisting of hashing only a portion of the Raw Element and not all the bits—which is completed in an accelerated process to minimize disruption for the collaborators. Once the hashing process is complete, the Raw Element will appear online and also all metadata associated with the Raw Element will be made available. This streaming, caching, and hashing processes and quality of service take into account the user-defined and system-defined constraints of the Content Owner and collaborator to optimize the streaming experience.

In addition, a Strada system solves the following two problems faced by the field of media production: AI Model Training licensing, and monetizing archives by making them available to potential customers.

The following is the background contexts for the other aspects of challenges faced by the field of media production to/which a Strada system provides solutions and/or directions.

### Additional Embodiment Details

The present invention may be a system, a method, and/or a computer program product. The computer program product and the system may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device or a computer cloud via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, Java, Python or the like, and conventional procedural programming languages, such as the “C” programming language or similar programming languages, and scripting programming languages, such as Perl, JavaScript, or the like. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In all embodiments, a production environment is employed to deploy and run a computing system. A production environment generally is an edge-device mounted on a moving vehicle, an on-premise computing system communicatively connected to the moving vehicle, or a remote cloud system communicatively connected to the moving vehicle. A production environment is different from a training environment in that the production environment feeds the computing system with a real-world input data, whereas a training environment usually feeds a computing system with a pre-organized input data to train the computing system. A production environment is different from a testing environment in that the testing environment feeds the computing system with testing input data which may not be a live production data. Sometimes, a production environment, a training environment, and a testing environment can overlap if they are crafted in a way not to interfere or burden the various production running in the production environment.

### Additional Notes

All references, including publications, patent applications, and patents, cited herein are hereby incorporated by reference to the same extent as if each reference were individually and specifically indicated to be incorporated by reference and were set forth in its entirety herein.

The uses of the terms of “media”, “media asset”, “media product”, “media file”, and “media product fragment”, in the context of describing the invention, are to be construed to mean a piece of media in its entirety.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Certain embodiments of this invention are described herein, including the best mode known to the inventors for carrying out the invention. It should be understood that the illustrated embodiments are exemplary only, and should not be taken as limiting the scope of the invention.

Benefits, other advantages, and solutions to problems have been described herein with regard to specific embodiments. However, the benefits, advantages, solutions to problems, and element(s) that may cause benefit, advantage, or solution to occur or become more pronounced are not to be construed as critical, required, or essential features or elements of the claims. Reference to an element in the singular is not intended to mean “one and only one” unless explicitly so stated, but rather “one or more.” As used herein, the terms “comprises”, “comprise”, “comprising”, or a variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for practice unless expressly described as “essential” or “critical”. Moreover, those skilled in the art will recognize that changes and modifications may be made to the exemplary embodiments without departing from the scope of the present invention. Thus, different embodiments may include different combinations, arrangements and/or orders of elements or processing steps described herein, or as shown in the drawing figures. For example, the various components, elements or process steps may be configured in alternate ways depending upon the particular application or in consideration of cost. These and other changes or modifications are intended to be included within the scope of the present invention, as set forth in the following claims.

What is claimed is:

1. A computer-implemented method for enabling collaborations among a project lead and a plurality of collaborators, comprising:
receiving or creating, by a plurality of collaborator computing systems, a plurality of media content fragments, storing the plurality of content fragments on the plurality of collaborator computing systems, surveying the plurality of collaborator computing systems to produce a set of collaborator data each of which represents infrastructure constraints of the collaborator computing system being surveyed, transmitting the set of collaborator data to an input and constraint synthesizer,
creating a set of project data by a project lead computer system, and transmitting the set of project data to the input and constraint synthesizer, wherein the input and constraint synthesizer aggregating the set of collaborator data and the set of project data, to produce a set of overall inputs and constraints, and transmitting the set of overall inputs and constraints to an optimizer and orchestrator,
receiving a media production workflow by the optimizer and orchestrator,
producing, by the optimizer and orchestrator, based on the set of overall inputs and constraints, an optimized workflow, distributing the optimized workflow, according to a distribution plan specified in the optimized workflow, to a second plurality of collaborator computing systems wherein each of the collaborator computing systems in the second plurality of collaborator computing systems receives a portion of the optimized workflow to process, and collectively, the second plurality of collaborator computing systems produce a set of outputs, and wherein the second plurality of collaborator computing systems are a subset of the plurality of collaborator computing systems,
assembling, by a product synthesizer, and according to the distribution plan, the set of outputs into a final product.

2. The computer-implemented method of claim 1, wherein each of the set of collaborator data includes software, hardware and network constraints corresponding to a collaborator computing system of the set of plurality of collaborator computing systems, and the set of project data includes project type, available budget, available time, volume of work, security requirements, and project preferences.

3. A computer-implemented method for computing resources sharing among a plurality of computing systems to an overall computing system wherein the plurality of computer systems are communicatively connected, comprising:
registering each of the plurality of computing systems to the overall computing system, surveying each of the plurality of computing systems for its software and hardware resources to produce a set of resource description data describing the software and hardware resources thereon, transmitting and registering the set of resource description data to a database, and installing an app on each of the plurality of computing systems wherein the app monitors the idle/active status of the computing system on which the app is installed, wherein the plurality of computing systems being registered include a first participant computing system,
issuing a resource request, by the first computing system, to a controller that is communicatively connected with the overall computing system, wherein the resource request specifies a resource being requested and the characteristics of the resource being requested,
searching the database, by the controller, to locate all computing systems being registered, sending a probing message to the app installed on each of the computing systems being registered to find out which have an idled and fitting resource,
receiving a notification, by the controller, from each of the computing systems being registered via the app installed thereon wherein the notification indicates the idle/active status of the resource being requested on each of the computer systems being registered, and choosing a computing system that has an idle and fitting resource,
connecting, by the controller, the first app on the first computing system and the second app on the computing system being chosen,
the first app collaborating with the second app to avail the idled and fitting resource on the computing system being chosen to the first computing system.

4. The computer-implemented method of claim 3, further comprising: ensuring, by the second app, a user on the computing system being chosen is unable to see, access, and influence the use of the idled and fitting resource on the computing system being chosen once it is made avail to be used by the first computing system.

5. A computer-implemented method for media content transferring among a plurality of disparate network-connected storage devices, comprising:
for each media content located in each of the plurality of disparate network-connected storage devices, creating a registration therefor and storing the registration on a virtual folder or a workflow of a media content coordinator, wherein the registration therefor includes a description and a location thereof,
receiving, by the media content coordinator, a content request from a content creator that has established log-in credentials with the media content coordinator, wherein the content request includes a description of a requested media content,
searching and locating, by the media content coordinator, based on the content request, in the virtual folder or the workflow, the requested media content,
transmitting the requested media content to the content creator.

6. The computer-implemented method of claim 5, wherein creating the registration for the media content further comprising generating metadata for the media content, storing the registration further comprising storing the metadata along with the media content along with a unique identifier being used to associate the media content with the metadata, and searching and locating further comprising searching for the description of the requested media content against metadata of all registered media contents and wherein the transmitting the requested media content to the content creator is through virtualization or streaming.

7. The computer-implemented method of claim 4, wherein creating the registration for the media content and storing the registration further comprising indexing the media content and making the media content discoverable to the plurality of disparate network-connected storage devices.

8. A computer-implemented method for gamma-corrected viewing media content segments without altering the source of the media content segments, comprising:
upon receiving a first viewing request from a device to view a color corrected version of a first media content segment, creating, via virtualization, a first play-back from the first media content segment in a memory or a temporary storage of a computer system to which the device is communicatively connected,
applying, by the computer system, color correction to the first play-back to create a first streaming,
transmitting the first streaming to the device for viewing,
upon receiving a second viewing request from the device to view a combination of a second media content segment and a third media content segment, creating a second play-back from the second media content segment in the memory or a temporary storage of the computer system, creating a third play-back from the third media content segment in the memory or the temporary storage of the computer system,
combining, by the computer system, the second play-back with the third play-back to create a second streaming,
transmitting the second streaming to the device for viewing.

9. The computer-implemented method of claim 8, wherein applying, by the computer system, color correction to the first play-back to create a first streaming further comprising: taking into account a set of infrastructure constraints of the computer that hosts or supports the devices, and wherein combining, by the computer system, the second play-back with the third play-back to create the second streaming further comprising: taking into account of the set of infrastructure constraints of the computer that hosts or supports the device.

10. The computer-implemented method of claim 8, wherein applying, by the computer system, color correction to the first play-back to create a first streaming further comprising: taking into account a set of user-defined constraints and a set of infrastructure constraints of the computer that hosts or supports the device, and wherein combining, by the computer system, the second play-back with the third play-back to create the second streaming further comprising: taking into account a second set of user-defined constraints and the set of infrastructure constraints of the computer that hosts or supports the device, wherein the second set of user-defined constraints are supplied along with the first viewing request and/or the second viewing request.

11. A computer-implemented method for playing back a plurality of media content segments simultaneously without altering the source of the plurality of media content segments, comprising:
upon receiving a viewing request from a device to view the plurality of media content segments, creating a plurality of copies of the plurality of media content segments in a memory or a temporary storage of a computer system to which the device is communicatively connected, wherein each of the plurality of copies corresponds to a media content segment of the plurality of media content segments,
for each copy of the plurality of copies, retrieving, by the computer system, a time code embedded in the each of the plurality of copies, to produce a plurality of time codes each of which corresponds to a copy of the plurality of copies,
aligning, by the computer system, the plurality of time codes according to time values thereof,
playing back and streaming to the device for viewing, by the computer system, the plurality of copies simultaneously and in-sync with to the plurality of time codes that have been aligned.

12. The computer-implemented method of claim 11, wherein the playing back and streaming to the device for viewing takes into account the infrastructure constraints of the computer that hosts or supports the device.

13. The computer-implemented method of claim 11, wherein the playing back and streaming to the device for viewing takes into account of a set of infrastructure constraints of the computer that hosts or supports the device and a set of user-defined constraints, wherein the set of user-defined constraints are supplied along with the viewing request.

14. The computer-implemented method of claim 11, wherein the playing back and streaming to the device for viewing further comprising: locally caching one or more specific user-defined moments of streaming, wherein the one or more specific user-defined moments are input from a user through the device.

15. A computer-implemented method for optimizing a media production workflow and tracking the costs of the workflow, comprising:
retrieving the plurality of previously completed media production workflows from a database, wherein the plurality of previously completed media production workflows being retrieved are compositionally similar to a media production workflow,
for each of the plurality of previously completed media production workflows being retrieved, retrieving the total costs incurred and total time consumed of the respective workflow, and the position-cost-time dataset of each step in the respective workflow to produce a set of previous data,
producing an optimization configuration for the steps in the plurality of previously completed media production workflows being retrieved based on the set of previous data by shuffling the positions of each step in the plurality of previously completed media production workflows being retrieved to find out which order of execution of steps in the plurality of previously completed media production workflows being retrieved will result in the lowest total cost incurred and time consumed, wherein the optimal configuration encodes the order of execution of steps in the plurality of previously completed media production workflows being retrieved that will result in the lowest total cost incurred and time consumed,
running the media production workflow according to the optimization configuration to obtain a recommended workflow, wherein the recommended workflow bears the closest compositional resemblance to the media production workflow, re-arranging the steps in the media production workflow according to the configuration of the recommended workflow to produce an optimized workflow for the media production workflow,
running the optimized workflow,
registering a position, a cost incurred and a time consumed in completing each step of the optimized workflow to produce a plurality of position-cost-time values respective to each completed step of the optimized workflow,
upon completing the optimized workflow, tallying the plurality of position-cost-time values to produce a total cost value and a total time value associated with the optimized workflow,
storing the optimized workflow along with the plurality of position-cost-time values, the total cost value and the total time value associated with the optimized workflow in the database.

16. A computer-implemented method for enhancing manual operations in a media production workflow, comprising:
retrieving a plurality of previously completed media production workflows, wherein an overall preference of each of the plurality of previously completed media production workflows is known and quantitively encoded, and the preference and operational option of each step of the plurality of previously completed media production workflows are known and quantitively encoded, and wherein the plurality of previously completed media production workflows being retrieved are compositionally similar to the media production workflow,
running the media production workflow through the plurality of previously completed media production workflows being retrieved to obtain a recommended workflow, wherein the recommended workflow's overall preference bears the closest resemblance to the media production workflow's overall preference, assigning a preference and operational option to each step in the media production workflow according to the preference and operational option associated with the corresponding step in the recommended workflow to produce an enhanced workflow for the media production workflow,
running the enhanced workflow, wherein the running is carried on, without human interference, by executing each step therein according to the assigned preference and operational option thereof.

17. A computer-implemented method for expediting operations in a media production workflow, comprising:
retrieving a plurality of steps from the media production workflow,
conducting dependency analysis on the plurality of steps to build a diagram of dependency for the plurality of steps, wherein the diagram of dependency specifies a number of dependency links among the plurality of distinct steps,
retrieving a plurality of previously completed and compositionally similar media production workflows, wherein the cost incurred and time consumed are known for each step of the plurality of previously completed and compositionally similar media production workflows,
for each of the plurality of previously completed and compositionally similar media production workflows, tallying the total costs incurred, total time consumed, individual cost incurred in each step, and individual time consumed in each step, and the position of each step in the respective previously completed and compositionally similar media production workflow to produce a plurality of cost-time constraints, each of which corresponds to each of the plurality of previously completed and compositionally similar media production workflows, wherein each of the plurality of cost-time constraints includes constraint datapoints encompassing cost incurred, time consumed and position for each step in a workflow of the plurality of previously completed and compositionally similar media production workflows,
for each of the plurality of previously completed and compositionally similar media production workflows, analyzing each step therein to identify virtually-executable steps therein that can be executed virtually in a memory or a temporary storage without being actually executed in a production storage, to assemble a plurality of virtually-executable step tables containing such steps for the plurality of previously completed and compositionally similar media production workflows,
running the media production workflow through the plurality of previously completed and compositionally similar media production workflows being retrieved to obtain a recommended workflow, wherein the recommended workflow bears the lowest cost incurred and time consumed,
retrieving a recommended set of cost-time constraints from the plurality of cost-time constraints corresponding to the recommended workflow, and a recommended virtually-executable step table from the plurality of virtually-executable step tables corresponding to the recommended workflow,
reconciling the diagram of dependency, the recommended set of cost-time constraints, and the recommended virtually-executable step table to produce a parallelization plan, wherein each parallelization specifies two or more steps of the media production workflow that are executed in parallel by two or more collaborators, and each parallelization conforms with the diagram of dependency, optimally conforms with the recommended set of cost-time constraints, and conforms with the recommended set of virtually-executable step tables,
executing the recommended workflow according to the parallelization plan.

18. A computer-implemented method for enabling query media fragments stored in a plurality of networked storage devices of a media production environment, comprising:
communicatively connecting and granting access the media production environment to the plurality of networked storage devices,
traversing, by the media production environment, through the plurality of networked storage devices to identify a plurality of media fragments contained therein,
producing, for each of the plurality of media fragments, metadata describing each of the plurality of media fragments wherein the metadata contains an unique identifier for the each of the plurality of media fragments and an unique address in the plurality of networked storage devices, analyzing each of the plurality of media fragments to detect an existence of each of a plurality of pre-defined subject matters, upon detecting the existence thereof, adding the names of detected subject matter as tags to the metadata, storing the metadata along with the each of the plurality of media fragments in a database communicatively connected to the media production environment,
receiving, by the media production environment, a media fragment query, wherein the query includes a plurality of descriptive keywords,
conducting, by the media production environment, a database search against the database, wherein the database search entails comparing the plurality of descriptive keywords with the tags in each of metadata stored in the database,
presenting a plurality of matched metadata each of which matches at least one of the plurality of descriptive keywords, wherein the plurality of matched metadata each has an URL (Uniform Resource Locator) representing an identifiable location within the plurality of network storage for accessing the associated media fragment.

19. The computer-implemented method of claim 18, further comprising:
updating the plurality of pre-defined subject matter,
traversing, by the media production environment, through the plurality of networked storage devices to identify a plurality of media fragments contained therein,
analyzing, by the media production environment, each of the plurality of media fragments to detect the existence of each of the plurality of pre-defined subject matter that have just been updated, upon detecting an existence thereof, retrieving the metadata associated with each of the plurality of media fragments from the database system and updating, by overwriting the tags therein with the names of detected subject matters as tags.

20. The computer-implemented method of claim 18, further comprising:
upon adding a new media fragment in the plurality of networked storage devices, producing, by the media production environment, new metadata describing the new media fragment wherein the new metadata contains a new unique identifier for the new media fragment and a new unique address in the plurality of networked storage devices, analyzing the new media fragment to detect an existence of each of the plurality of pre-defined subject matter, upon detecting the existence thereof, adding the names of detected subject matter as tags to the new metadata, storing the new metadata in the database system.

21. The computer-implemented method of claim 18, wherein storing the metadata along with each of the plurality of media fragments in the database system communicatively connected to the media production environment further comprising: indexing each of the plurality of media fragments according to its metadata and making each of the plurality of media fragments discoverable according to its metadata.

22. The computer-implemented method of claim 18, further comprising:
upon detecting a media fragment that is previously stored and indexed in the database system being offline for a user-defined time period, designating, in the database system, the media fragment as “offline”, making the media fragment inaccessible and undiscoverable,
upon detecting a media fragment that is designated as “offline” becoming online, removing, in the database system, the designation of “offline” from the media fragment, making the media fragment accessible and discoverable.

23. A media content creation and collaboration system, comprising:
a plurality of collaborator computing systems,
a project lead computing system,
an inputs and constraints synthesizer system,
a product synthesizer, and
an optimizer and orchestrator, wherein the plurality of collaborator computing systems, the project lead computing system, the inputs and constraints synthesizer system, the product synthesizer and the optimizer and orchestrator are communicatively connected, and the media content creation and collaboration system to perform operations comprising:
receiving or creating, by the plurality of collaborator computing systems, a plurality of media content fragments, storing the plurality of content fragments on the plurality of collaborator computing systems, surveying the plurality of collaborator computing systems to produce a set of collaborator data each of which represents infrastructure constraints of the collaborator computing system being surveyed, transmitting the set of collaborator data, to an input and constraint synthesizer,
creating a set of project data by a project lead computer system, and transmitting the set of project data to the input and constraint synthesizer, wherein the input and constraint synthesizer aggregates the set of collaborator data and the set of project data, to produce a set of overall inputs and constraints, and transmitting the set of overall inputs and constraints to the optimizer and orchestrator,
receiving a media production workflow by the optimizer and orchestrator,
producing, by the optimizer and orchestrator, based on the set of overall inputs and constraints, an optimized workflow, distributing the optimized workflow, according to a distribution plan specified in the optimized workflow, to a second plurality of collaborator computing systems wherein each of the collaborator computing systems in the second plurality of collaborator computing systems receives a portion of the optimized workflow to process, and collectively, the second plurality of collaborator computing systems produce a set of outputs, and wherein the second plurality of collaborator computing systems are a subset of the plurality of collaborator computing systems,
assembling, by a product synthesizer, and according to the distribution plan, the set of outputs into a final product.

24. The media content creation and collaboration system of claim 23, wherein each of the set collaborator data includes software, hardware and network constraints corresponding to a collaborator computing system of the set of plurality of collaborator computing systems, and the set of project data includes project type, available budget, available time, volume of work, security requirements, and project preferences.

25. A media content creation and collaboration system, comprising:
a controller,
a database,
a plurality of computing systems,
wherein the plurality of computing systems, the controller, and the database are communicatively connected, and the controller is a computer or a software module hosted in a computer, and the media content creation and collaboration system to perform operations comprising:
registering each of the computing systems to the media content creation and collaboration system, and for each of the computing systems, surveying software and hardware resources thereon to produce a set of resource description data describing the software and hardware resources thereon, transmitting and registering the set of resource description data to the database, and installing an app on each of the computing systems wherein the app monitoring each of the computing system's idle/active status, wherein the computing systems include a first computing system,
issuing a resource request, by the first computing system, to the controller, wherein the resource request specifies a resource being requested and the characteristics of the resource being requested,
searching the database, by the controller, to locate all registered computing systems, sending a probing message to the app installed on each of the registered computing systems to find out which of the registered computing systems have idle resources,
receiving a notification, by the controller, from each of the registered computing systems via the app installed thereon wherein the notification indicates the idle/active status of each of the registered computer systems, and choosing a computing system that has an idle and fitting resource,
connecting, by the controller, the first app on the first computing system and the second app on the computing system being chosen,
the first app collaborating with the second app to avail an idled and fitting resource on the computing system being chosen to the first computing system.

26. A media content creation and collaboration system of claim 25, the media content creation and collaboration system to perform operations further comprising: ensuring, by the second app, a user on the computing system being chosen is unable to see, access, and influence the use of the idled and fitting resource on the computing system being chosen once it is made available to be used by the first computing system.

27. A media content transferring system, comprising:
a plurality of disparate network-connected storage devices,
a media content coordinator that has a virtual folder,
wherein the plurality of disparate network-connected storage devices and the media content coordinator are communicatively connected, and the media content coordinator to perform operations comprising:
for each media content located in each of the plurality of disparate network-connected storage devices, creating a registration therefor and storing the registration on a virtual folder or a workflow of the media content coordinator, wherein the registration therefor includes a description thereof and a location thereof,
receiving, by the media content coordinator, a content request from a content creator that has established log-in credentials with the media content coordinator, wherein the content request includes a description of a requested media content,
searching and locating, by the media content coordinator, based on the content request, in the virtual folder or the workflow, the requested media content,
transmitting the requested media content to the content creator.

28. The media content transferring system of claim 27, wherein creating the registration for the media content further comprising generating metadata for the media content, storing the registration further comprising storing the metadata along with the media content, and searching and locating further comprising searching for the description of the requested media content against metadata of all registered media contents, and wherein transmitting the requested media content to the content creator is through virtualization or streaming.

29. The media content transferring system of claim 27, wherein creating the registration for the media content and storing the registration further comprising indexing the media content and making the media content discoverable to the plurality of disparate network-connected storage devices.

30. A media content viewing system, comprising:
a device,
a computer system that hosts a plurality of media content segments, and the media content viewing system to perform operations comprising:
upon receiving a first viewing request from a device to view a color corrected version of a first media content segment, creating, via virtualization, a first play-back from the first media content segment in a memory or a temporary storage of a computer system to which the devicer is communicatively connected,
applying, by the computer system, color correction to the first play-back to create a first streaming,
transmitting the first streaming to the device for viewing,
upon receiving a second viewing request from the device to view a combination of a second media content segment and a third media content segment, creating a second play-back from the second media content segment in the memory or a temporary storage of the computer system, creating a third play-back from the third media content segment in the memory or the temporary storage of the computer system,
combining, by the computer system, the second play-back with the third play-back to create a second streaming,
transmitting the second streaming to the device for viewing.

31. The media content viewing system of claim 30, wherein applying, by the computer system, color correction to the first play-back to create a first streaming further comprising: taking into account a set of infrastructure constraints of the computer that hosts or supports the device, and wherein combining, by the computer system, the second play-back with the third play-back to create the second streaming further comprising: taking into account the set of infrastructure constraints of the computer that hosts or supports the device.

32. The media content viewing system of claim 30, wherein applying, by the computer system, color correction to the first play-back to create a first streaming further comprising: taking into account a set of user-defined constrains and a set of infrastructure constraints of the computer that hosts or supports the device, and wherein combining, by the computer system, the second play-back with the third play-back to create the second streaming further comprising: taking into account a second set of user-defined constraints and the set of infrastructure constraints of the computer that hosts or supports the device, wherein the second set of user-defined constraints are supplied along with the first viewing request and/or the second viewing request.

33. A media content viewing system, comprising:
a device,
a computer system that hosts a plurality of media content segments, and the media content viewing system to perform operations comprising:
upon receiving a viewing request from the device to view the plurality of media content segments, creating a plurality of copies of the plurality of media content segments in a memory or a temporary storage of the computer system to which the device is communicatively connected, wherein each of the plurality of copies corresponds to a media content segment of the plurality of media content segments,
for each copy of the plurality of copies, retrieving, by the computer system, a time code embedded in the each of the plurality of copies, to produce a plurality of time codes each of which corresponds to a copy of the plurality of copies,
aligning, by the computer system, the plurality of time codes according to time values thereof,
playing back and streaming to the web browser for viewing, by the computer system, the plurality of copies simultaneously and in-sync with to the plurality of time codes that have been aligned.

34. The media content viewing system of claim 33, wherein the playing back and streaming to the device for viewing takes into account the infrastructure constraints of the computer that hosts or supports the device.

35. The media content viewing system of claim 33, wherein playing back and streaming to the device for viewing takes into account a set of infrastructure constraints of the computer that hosts or supports the device and a set of user-defined constraints, wherein the set of user-defined constraints are supplied along with the viewing request.

36. The media content viewing system of claim 33, wherein playing back and streaming to the device for viewing further comprising: locally caching one or more specific user-defined moments of streaming, wherein one or more specific user-defined moments are input from a user through the device.

37. A media production workflow optimization and cost-tracking system, comprising:
a database that stores a plurality of previously completed media production workflows, wherein the composition and configuration of each of the plurality of previously completed media production workflows are recorded, and the position, cost incurred and time consumed of each of the step (position-cost-time dataset) in each of the plurality of previously completed media production workflows are recorded,
a computer system that is communicatively connected to the database, and hosts a media content workflow, and the computer system to perform operations comprising:
retrieving the plurality of previously completed media production workflows from the database, wherein the plurality of previously completed media production workflows being retrieved are compositionally similar to the media production workflow,
for each of the plurality of previously completed media production workflows, retrieving the total costs incurred and total time consumed of the respective workflow, and the position-cost-time dataset of each step in the respective workflow to produce a set of previous data,
producing an optimization configuration for the steps in the plurality of previously completed media production workflows being retrieved based on the set of previous data by shuffling the positions of each step in the plurality of previously completed media production workflows being retrieved to find out which order of execution of steps in the plurality of previously completed media production workflows being retrieved would result in the lowest total cost incurred and time consumed, wherein the optimal configuration encodes the order of execution of steps in the plurality of previously completed media production workflows being retrieved that will result in the lowest total cost incurred and time consumed,
running the media production workflow according to the optimization configuration to obtain a recommended workflow, wherein the recommended workflow bears the closest compositional resemblance to the media production workflow, re-arranging the steps in the media production workflow according to the configuration of the recommended workflow to produce an optimized workflow for the media production workflow,
running the optimized workflow,
registering a position, a cost incurred and a time consumed in completing each step of the optimized workflow to produce a plurality of position-cost-time values respective to each completed step of the optimized workflow,
upon completing the optimized workflow, tallying the plurality of position-cost-time values to produce a total cost value and a total time value associated with the optimized workflow,
storing the optimized workflow along with the plurality of position-cost-time values, the total cost value and the total time value associated with the optimized workflow in the database.

38. A media production workflow enhancement system, comprising:
a database system that stores a plurality of previously completed media production workflows, wherein an overall preference of each of the plurality of previously completed media production workflows is known and quantitively encoded, and the preference and operational option of each step of the plurality of previously completed media production workflows are known and quantitively encoded,
a computer system that is communicatively connected to the database system, and hosts a media content workflow, and the computer system to perform operations comprising:
retrieving a plurality of previously completed and similar media production workflows from the database system, wherein the plurality of previously completed and similar media production workflows are compositionally similar to a media production workflow,
running the media production workflow through the plurality of previously completed and similar media production workflows to obtain a recommended workflow, wherein the recommended workflow's overall preference bears the closest resemblance to the media production workflow's overall preference, assigning a preference and operation option to each step in the media production workflow according to the preference and operational option associated with the corresponding step in the recommended workflow to produce an enhanced workflow for the media production workflow,
running the enhanced workflow, wherein the running is carried on, without human interference, by executing each step therein according to the assigned preference and operation option thereof.

39. A media production workflow parallelization system, comprising:
a database system that stores a plurality of previously completed media production workflows, wherein the composition and configuration of each of the plurality of previously completed media production workflows are recorded, and the cost incurred and time consumed of each of the steps in each of the plurality of previously completed media production workflows are recorded,
a computer system that is communicatively connected to the database system, and hosts a media content workflow, and the computer system to perform operations comprising:
retrieving a plurality of steps from the media production workflow,
conducting dependency analysis on the plurality of steps to build a diagram of dependency for the plurality of steps, wherein the diagram of dependency specifies a number of dependency links among the plurality of distinct steps,
retrieving a plurality of previously completed and compositionally similar media production workflows from the database system,
for each of the plurality of previously completed and compositionally similar media production workflows, tallying the total costs incurred, total time consumed, individual cost incurred in each step, and individual time consumed in each step, and the position of each step in the respective previously completed media production workflow to produce a plurality of cost-time constrains each of which corresponds to each of the plurality of previously completed and compositionally similar media production workflows, wherein each of the plurality of cost-time constrains includes constrain datapoints encompassing cost incurred, time consumed and position for each step in a workflow of the plurality of previously completed and compositionally similar media production workflows,
for each of the plurality of previously completed and compositionally similar media production workflows, analyzing each step therein to identify virtually-executable steps therein that can be executed virtually in a memory or a temporary storage without being actually executed in a production storage, to assemble a plurality of virtually-executable step tables containing such steps for the plurality of previously completed and compositionally similar media production workflows,
running the media production workflow through the plurality of previously completed and compositionally similar media production workflows being retrieved to obtain a recommended workflow, wherein the recommended workflow bears the lowest cost incurred and time consumed,
retrieving a recommended set of cost-time constrains from the plurality of cost-time constrains corresponding to the recommended workflow, and a recommended virtually-executable step table from the plurality of virtually-executable step tables corresponding to the recommended workflow,
reconciling the diagram of dependency, the recommended set of cost-time constrains, and the recommended virtually-executable step table to produce a parallelization plan, wherein each parallelization specifies two or more steps of the media production workflow are executed in parallel by two or more collaborators, and the each parallelization conforms with the diagram of dependency, optimally conforms with the recommended set of cost-time constrains, and conforms with the recommended set of virtually-executable step table,
executing the recommended workflow according to the parallelization plan.

40. A media query system, comprising:
a database,
a media production environment communicatively connected to the database, the media production environment to perform operations comprising:
communicatively connecting the media production environment to the plurality of networked storage devices and obtaining access to the networked storage devices,
traversing, by the media production environment, through the plurality of networked storage devices to identify a plurality of media fragments contained therein,
producing, for each of the plurality of media fragments, a metadata describing the each of the plurality of media fragments wherein the metadata contains an unique identifier for the each of the plurality of media fragments and an unique address in the plurality of networked storage device, analyzing the each of the plurality of media fragments to detect an existence of each of a plurality of pre-defined subject matters, upon detecting the existence thereof, adding the names of detected subject matters as tags to the metadata, storing the metadata in the database system,
receiving, by the media production environment, a media fragment query, wherein the query includes a plurality of descriptive keywords,
conducting, by the media production environment, a database search against the database, wherein the database search entails comparing the plurality of descriptive keywords with the tags in each of metadata stored in the database system,
presenting a plurality of matched metadata each of which matches at least one of the plurality of descriptive keywords, wherein the plurality of matched metadata each has an URL (Uniform Resource Locator) representing an identifiable location within the plurality of network storages for accessing the associated media fragment.

41. The media query system of claim 40, the media production environment to perform operation further comprising:
updating the plurality of pre-defined subject matter,
traversing, by the media production environment, through the plurality of networked storage devices to identify a plurality of media fragments contained therein,
analyzing, by the media production environment, each of the plurality of media fragments to detect the existence of each of the plurality of pre-defined subject matter that has just been updated, upon detecting an existence thereof, retrieving the metadata associated with each of the plurality of media fragments from the database system and updating, by overwriting the tags therein with the names of detected subject matter as tags.

42. The media query system of claim 40, the media production environment to perform operation further comprising:
upon adding a new media fragment in the plurality of networked storage devices, producing, by the media production environment, new metadata describing the new media fragment wherein the new metadata contains a new unique identifier for the new media fragment and a new unique address in the plurality of networked storage devices, analyzing the new media fragment to detect an existence of each of the plurality of pre-defined subject matter, upon detecting the existence thereof, adding the names of detected subject matter as tags to the new metadata, storing the new metadata in the database system.

43. The media query system of claim 40, wherein storing the metadata along with each of the plurality of media fragments in the database communicatively connected to the media production environment further comprising: indexing each of the plurality of media fragments according to its metadata and making each of the plurality of media fragments discoverable according to its metadata.

44. The media query system of claim 40, the media production environment to perform operations further comprising:
upon detecting a media fragment that is previously stored and indexed in the database system being offline for a user-defined time period, designating, in the database system, the media fragment as “offline”, making the media fragment inaccessible and undiscoverable, upon detecting a media fragment that is designated as “offline” becoming online, removing, in the database system, the designation of “offline” from the media fragment, making the media fragment accessible and discoverable.
